(19) United States
(12) Patent Application Publication
(10) Pub. No.: US 2024/0253661 A1
(43) Pub. Date: Aug. 1, 2024

(54) System for Software-Based Emulation of Wireless Communication Environments for Autonomous Vehicles

(71) Applicant: Northeastern University, Boston, MA (US)

(72) Inventors: Debashri ROY, Arlington, MA (US); Kaushik CHOWDHURY, Needham, MA (US)

(21) Appl. No.: 18/423,247

(22) Filed: Jan. 25, 2024

Related U.S. Application Data
(60) Provisional application No. 63/441,175, filed on Jan. 25, 2023.

(51) Int. Cl. B60W 60/00; H04W 4/44

(52) U.S. Cl. CPC B60W 60/001; H04W 4/44; B60W 2420/403

(57) ABSTRACT

Systems and methods are provided for selecting a beam direction of mm wave transmission for use by a vehicle operating within a network environment. The systems and methods include collecting data from a plurality of sensors on the vehicle to detect obstructions and other changes to an environment of the vehicle and of a base station that communicates with the vehicle. The systems and methods further include a library of digital twins, which are a virtual representation of the real-world environment, to identify beam directions of varying signal-to-noise ratios. The systems and methods further include determining from the data collected from the plurality of sensors a preferred digital twin and using the beam direction data corresponding to the digital twin to determine a beam direction for a transmitter of the vehicle to communicate with a receiver of the base station.

### CROSS REFERENCE TO RELATED APPLICATIONS

This application claims the priority of U.S. Provisional Application No. 63/441,175 filed Jan. 25, 2023 and entitled “System for Software-Based Emulation of Wireless Communication Environments for Autonomous Vehicles”, the whole of which is hereby incorporated by reference.

### STATEMENT REGARDING FEDERALLY SPONSORED RESEARCH OR DEVELOPMENT

This invention was made with government support under Grant Numbers 2112471 and 1937500 awarded by the National Science Foundation. The government has certain rights in the invention.

### BACKGROUND

The previous state-of-the-art solves the problem of beam selection in millimeter wave (mmWave) band by: (i) probing all the sectors in 802.11d, (ii) extracting full channel state information, (iii) using a compressive path tracking algorithm, (iv) exploiting channel state information at Sub-6 GHz frequency to infer the optimum sector at high-band mmWave frequencies, (v) applying a deep learning based model using images, light detection and ranging (LiDAR) data, and global positioning system (GPS) sensor data to reduce the sector search space at mmWave band. Nevertheless, a challenge arises when the deep learning model for inferring the beam decision needs to perform in test environments that have not been encountered previously during training. This may be, for example, a new street or a temporary, large obstruction not seen during training. Such situations result in unpredictable wireless propagation conditions that cannot be fully characterized without new radio frequency (RF) information.

### SUMMARY

The present technology provides systems and methods for selecting a beam direction when an environmental change, such as an obstruction of radio or microwave beams by a large truck, construction site, or new building, is detected by sensors of an autonomous vehicle. A network edge server may be used to store a multiverse of digital twins (e.g., a library) corresponding to locations of base stations. The digital twins include a set of alternative beam directions. One or more digital twins corresponding to the current location and environment of the autonomous vehicle may be identified at the network edge server. The one or more digital twins provide beam direction data for a transceiver of the autonomous vehicle to communicate with a base station. The autonomous vehicle may sweep through provided beam direction data to identify the strongest signal for communicating with the base station. This makes it possible to replace and correct erroneous deep learning (DL) predictions in the presence of a new environment, while still avoiding the latency of exhaustive sweep, as defined by standards.

An aspect of the present technology is a system for operating an autonomous vehicle in a local environment, such as a street in an urban environment. The system includes an autonomous vehicle and an edge server. The vehicle includes a computer, one or more sensors, and a transceiver for communication with a wireless network positioned in the local environment. The edge server is in communication with the wireless network and, through the wireless network, with the vehicle, through its transceiver. The edge server can optionally be in communication also with a cloud server. The vehicle computer possesses a trained model of the local environment and instructions for evaluating data from the sensors, identifying a change in the local environment compared to the trained model, and updating the trained model. The edge server possesses instructions for producing a multiverse of twins of the local environment and selecting a preferred one of the twins upon request from the autonomous vehicle. The multiverse of twins includes two or more twins of the local environment. The twins differ from one another in one or more representation factors of the local environment. The representation factors can include, for example, one or more reflections of one or more electromagnetic beams of the wireless network, or an image resolution. The use of twins differing by the number of reflections or differing by resolution of an image of the environment can be used to identify the optimal twin for enabling the vehicle computer to identify the best beam or beam reflection which can be used to allow the vehicle to maintain communication with a network.

Another aspect of the present technology is a method of operating an autonomous vehicle in a local environment. The method includes the following steps: determining a change in the local environment by comparing data from one or more sensors of the autonomous vehicle to stored data representing the local environment; transmitting the sensor data representing the local environment from a vehicle transceiver to an edge server; determining, based on the sensor data, a preferred twin from a multiverse of twins, wherein the multiverse of twins comprises two or more twins of the local environment differing from one another in one or more representation factors of the local environment; transmitting the preferred twin from the edge server to the transceiver of the autonomous vehicle; determining, using the preferred twin, beam direction data for communicating with a base station in the local environment; and transmitting, based on the beam direction data, data from the vehicle transceiver to the base station.

Yet another aspect of the present technology is a system for operating an autonomous vehicle in a local environment. The system includes at least one processor and a memory. The memory includes instructions that, when executed by the at least one processor, cause the at least one processor to: determine, using sensor data from one or more vehicle sensors, a change in the local environment by comparing the sensor data from the vehicle sensors to stored data representing the local environment; transmit, from a vehicle transceiver to an edge server, the sensor data representing the local environment; determine, based on the sensor data, a preferred twin from a multiverse of twins, wherein the multiverse of twins comprises two or more twins of the local environment differing from one another in one or more representation factors of the local environment; transmit the preferred twin from the edge server to the transceiver of the autonomous vehicle; determine, using the preferred twin, beam direction data for communicating with a base station in the local environment; and transmit, based on the beam direction data, data from the vehicle transceiver to the base station.

The technology can be further summarized with the following listing of features.
1. A system for operating an autonomous vehicle in a local environment, the system comprising:
   (i) an autonomous vehicle comprising a computer, one or more sensors, and a transceiver for communication with a wireless network disposed in the local environment; and
   (ii) an edge server in communication with the wireless network and with a cloud server, wherein the edge server is in communication with the autonomous vehicle through the transceiver and the wireless communications network;
   wherein the vehicle computer comprises a trained model of the local environment and instructions for evaluating data from the sensors, identifying a change in the local environment compared to the trained model, and updating the trained model; and
wherein the edge server comprises instructions for producing a multiverse of twins of the local environment and selecting a preferred one of said twins upon request from the autonomous vehicle.
2. The system of feature 1, wherein the sensors comprise one or more of a camera, a geographical positioning system (GPS) receiver, and a light detection and ranging (LiDAR) device.
3. The system of feature 1 or 2, wherein the cloud server and/or the edge server comprise one or more twins of the local environment or other data for use and/or modification in producing the multiverse of twins.
4. The system of any of the preceding features, wherein the local environment is an urban environment.
5. The system of any of the preceding features, wherein the change in the local environment comprises one or more of a road blocking vehicle or object, a detour, a building, a construction site, first responder activity, a pedestrian, a fire, or a weather-related hazard.
6. The system of any of the preceding features, wherein the multiverse of twins comprises two or more twins of the local environment differing from one another in one or more representation factors of the local environment.
7. The system of feature 6, wherein the representation factors are selected from a number of reflections of one or more electromagnetic beams of the wireless network and an image resolution.
8. The system of any of the preceding features, wherein the wireless network is a mmWave wireless network.
9. A method of operating an autonomous vehicle in a local environment, the method comprising the steps of:
   (a) determining a change in the local environment by comparing data from one or more sensors of the autonomous vehicle to stored data representing the local environment;
   (b) transmitting the sensor data representing the local environment from a vehicle transceiver to an edge server;
   (c) determining, based on the sensor data, a preferred twin from a multiverse of twins, wherein the multiverse of twins comprises two or more twins of the local environment differing from one another in one or more representation factors of the local environment;
   (d) transmitting the preferred twin from the edge server to the transceiver of the autonomous vehicle;
   (e) determining, using the preferred twin, beam direction data for communicating with a base station in the local environment; and
   (f) transmitting, based on the beam direction data, data from the vehicle transceiver to the base station.
10. The method of feature 9, wherein the representation factors are selected from a number of reflections of one or more electromagnetic beams of the wireless network and an image resolution.
11. The method of feature 9 or 10, wherein the vehicle sensor data are received from one or more of a camera, a GPS receiver, or a LiDAR device of the vehicle.
12. The method of any of features 9-11, wherein determining the preferred twin comprises identifying a latency constraint.
13. The method of feature 12, wherein the latency constraint is caused by blockage of one or more electromagnetic beams of the wireless network by said change in the local environment.
14. The method of feature 13, wherein determining the preferred twin comprises selecting a twin comprising information describing one or more reflections of the one or more blocked beams.
15. The method of any of features 9-14, wherein the wireless network is a mmWave wireless network.
16. The method of any of features 9-15, wherein step (c) comprises using an algorithm, and wherein the algorithm is

$${C}^{5 G - NR} ( K ) = {T}_{p} \times [ \frac{K - 1}{32} ] + {T}_{ssb} .$$

17. A system for operating an autonomous vehicle in a local environment, comprising:
   at least one processor; and
   memory including instructions that, when executed by the at least one processor, cause the at least one processor to:
      determine, using sensor data from one or more vehicle sensors, a change in the local environment by comparing the sensor data from the vehicle sensors to stored data representing the local environment;
      transmit, from a vehicle transceiver to an edge server, the sensor data representing the local environment;
      determine, based on the sensor data, a preferred twin from a multiverse of twins, wherein the multiverse of twins comprises two or more twins of the local environment differing from one another in one or more representation factors of the local environment;
      transmit the preferred twin from the edge server to the transceiver of the autonomous vehicle;
      determine, using the preferred twin, beam direction data for communicating with a base station in the local environment; and
      transmit, based on the beam direction data, data from the vehicle transceiver to the base station.
18. The system of feature 17, wherein the representation factors are selected from a number of reflections of one or more electromagnetic beams of the wireless network and an image resolution.
19. The system of feature 17 or 18, wherein the vehicle sensor data is received from one or more of a camera, a GPS receiver, and a LiDAR device of the vehicle.
20. The system of any of features 17-19, wherein the wireless network is a mmWave wireless network.
21. A method of operating an autonomous vehicle in a local environment, the method comprising the steps of:
   (a) providing the system of any of features 1-8;
   (b) identifying, using the vehicle computer and data from the one or more vehicle sensors, a first indication of a change in the local environment by comparing information from the vehicle sensors to the trained model of the local environment;
   (c) transmitting, from the vehicle transceiver to the edge server, first contextual data representing the changed environment;
   (d) preparing, at the edge server, a metaverse of twins of the local environment, wherein the metaverse of twins comprises two or more twins of the local environment differing from one another in one or more representation factors of the local environment;
   (e) determining a preferred twin of the metaverse of twins using an algorithm;
   (f) transmitting the preferred twin from the edge server to the transceiver of the autonomous vehicle;
   (g) modifying the trained model at the vehicle computer using the preferred twin; and
   (h) operating the autonomous vehicle using the modified baseline twin.

### BRIEF DESCRIPTION OF THE DRAWINGS

FIG. 1 illustrates a system overview of the multiverse concept with the real world and two different digital twins. The sensors on the vehicle capture the state of the real world. They may use this local information and use local deep learning (DL) models to choose a beam directly or invoke a twin from the multiverse. Each twin offers a distinct fidelity of emulation through ray-tracing and incurs a latency cost for delivering the beam selection results back to the vehicle and base station.

FIG. 2 illustrates a system model of the proposed multiverse-based beam selection approach. The lookup table is retrieved from the multiverse (at the edge) to the vehicle's local graphics processing unit (GPU) and used in the real world.

FIG. 3A illustrates Federated Learning for Automated Selection of High-band mmwave sectors (FLASH) experiment setup.

FIG. 3B illustrates an experiment location in real world.

FIG. 3C illustrates an experiment area in the virtual world (twin), showing the map beyond the area of interest in downtown Boston.

FIG. 3D illustrates a simulation location in twin, showing the first, middle, and last sample points, in order. The three-dimensional (3D) box between Tx and Rx100 models the car obstacle in the non-line-of-sight (NLOS) scenarios.

FIG. 4 illustrates a typical workflow in Wireless InSite (WI) for creating a twin (suppose Tᵢ for scenario Sᵤ) in the multiverse M.

FIG. 5A illustrates antenna pattern comparisons for Azimuth.

FIG. 5B illustrates antenna pattern comparisons for Elevation.

FIG. 5C illustrates antenna pattern comparisons for Tx Antenna-24 (t24)

FIG. 5D illustrates antenna pattern comparisons for Rx antenna.

FIG. 5E illustrates antenna pattern similarity: the definition of and 0 on the Cartesian coordinates and vector discrepancy calculation, where cT and cW I, are points in experimental and simulation antenna pattern, respectively, and c^{→}Δ is the vector difference between the cT and cW I.

FIG. 6A illustrates an example image of a twin with no obstructions and line-of-sight (LOS) beams in an open space environment.

FIG. 6B illustrates an example image of a twin with an obstruction and NLOS beams in an open space environment.

FIG. 6C illustrates an example image of a twin with no obstructions and LOS beams with up to one reflection in an urban canyon environment.

FIG. 6D illustrates an example image of a twin with an obstruction and NLOS beams with up to one reflection in an urban canyon environment.

FIG. 6E illustrates an example image of a twin with no obstructions and LOS beams with up to three reflections in an urban canyon environment.

FIG. 6F illustrates an example image of a twin with an obstruction and NLOS beams with up to three reflections in an urban canyon environment.

FIGS. 7A and 7B illustrate a benchmarking performance of three twins in a multiverse against the real-world measurements for LOS S1 and NLOS S2 scenarios. The accuracy for K=10 and SNR thresholds of 0, 1, 2 dB indicate the fidelity of the multiverse to the real-world settings. The 3-Reflection twin and 1-Reflection twin exhibits more fidelity over the Baseline twin.

FIGS. 8A and 8B are diagrams of the probability of inclusion for three twins for LOS S1 and NLOS S2 scenarios. Each column shows a region on the road and each row depicts the probability of inclusion for one of the twins. While the performance on twins varies in different regions, the 3-Reflection twin T3 outperforms the T1 and T2 on average. All twins offer higher probability of inclusion in S1 compared to S2. FIGS. 8A and 8B highlight a few sample regions where one twin has more fidelity than other.

FIG. 9A illustrates an Analysis of inclusion probability and beam selection time for different α values in Eq. 8 when the CComm is set to be less than 1 ms. The probability of inclusion decreases as the optimization problem is weighted on the second term in Eq. 8 that encourages minimizing the computation and communication cost. However, the beam selection time fluctuates as a result of alternating between choosing lower K or a twin with higher fidelity.

FIG. 9B illustrates the usage of twins when the computation constraints rules out 3-Reflection twin T3 in Eq. 8 with highest computation cost. When α=0, 1-Reflection twin T2 is used by 81.5% while Baseline twin T1 is selected by 18.5%. When α increases T1 is used more often to decrease the computation and communication time.

FIG. 9C illustrates the Acc(10,0) of machine learning-based method when augmented by the labels obtained by 3-Reflection twin T3. The Acc(10, 0) with augmentation is bounded by Acc(1,0)^{and} Acc(10,0) in multiverse. The max values are marked.

### DETAILED DESCRIPTION

Transmissions, such as beams in the millimeter-wave (mmWave) band, are highly directional. Thus, attempting to establish a directional communication from a moving entity (e.g., an autonomous vehicle) to a stationary entity (e.g., base station), a transmitter may sweep over multiple sectors one by one to find a direction where the signal is the strongest between the transmitter and the receiver of the base station. This sweeping process may be time consuming and thus may not be possible to be performed by an autonomous vehicle that is moving and may require data from a base station in a close to real-time manner. The methods and techniques described herein may utilize other sensor modalities (e.g., camera, GPS, LiDAR, etc.) to gain a wholistic representation of the environment of the autonomous vehicle. The wholistic representation may include changes to the environment which may correspond to blockages for the transmissions. When changes to the environment are detected, then a change in the best direction to point the beam for the transmitter may be required. The methods and techniques described herein may use representation (e.g., a twin) of the environment to speed up the beam forming selection, instead of performing an exhaustive search across all sectors, where each sector is probed one by one.

Provided herein are methods and techniques for selecting a beam when an environmental change is detected by the autonomous vehicle (e.g., a large truck blocking a receiver, construction, etc.). A digital twin at the network edge may be used that runs a ray tracing software to suggest a set of likely alternative beams. This makes it possible to replace and correct erroneous DL predictions in the presence of a new environment, while still avoiding the latency of exhaustive sweep, as defined by standards.

Creating a virtual world that closely mimics the real world with its many complex interactions and outcomes is possible today through advanced emulation software and ubiquitous computing power. Such a software-based emulation of an actual entity that exists in the real world is called a digital “twin”. Recent examples of such twins designed for manufacturing, oil and gas, construction and bio-engineering sectors rely on one specific realization of the twin in the virtual domain.

The methods and techniques described herein propose a twin of a wireless millimeter-wave band radio that is mounted on a vehicle and shows how it can speed up directional beam selection under mobile environments. The methods and techniques described herein further instantiate a single twin to utilize a “multiverse” paradigm, with several possible digital twins attempting to capture the real world at different levels of fidelity. The methods and techniques described herein include (i) a decision framework that decides when and which twin must be invoked given the computational and latency limitations for a beam selection use case, and (ii) a self-learning framework that uses the multiverse-guided beam selection outcomes to enhance local decision-making in the real world over time.

The present technology is distinguished from prior works as follows: First, it uses publicly available RF datasets collected from an autonomous car with actual systems-defined constraints for the different twins. Second, latency and computational constraints at the network edge shape the continuous interaction between the multiverse of twins, as opposed to a one-time emulation that is completed prior to actual deployment. Results reveal that the multiverse approach offers up to 79.43% and 85.22% top-10 accuracy for LOS and NLOS scenarios, respectively. Moreover, 52.72-85.07% improvement was observed in beam selection time compared to the 802.1 lad standard.

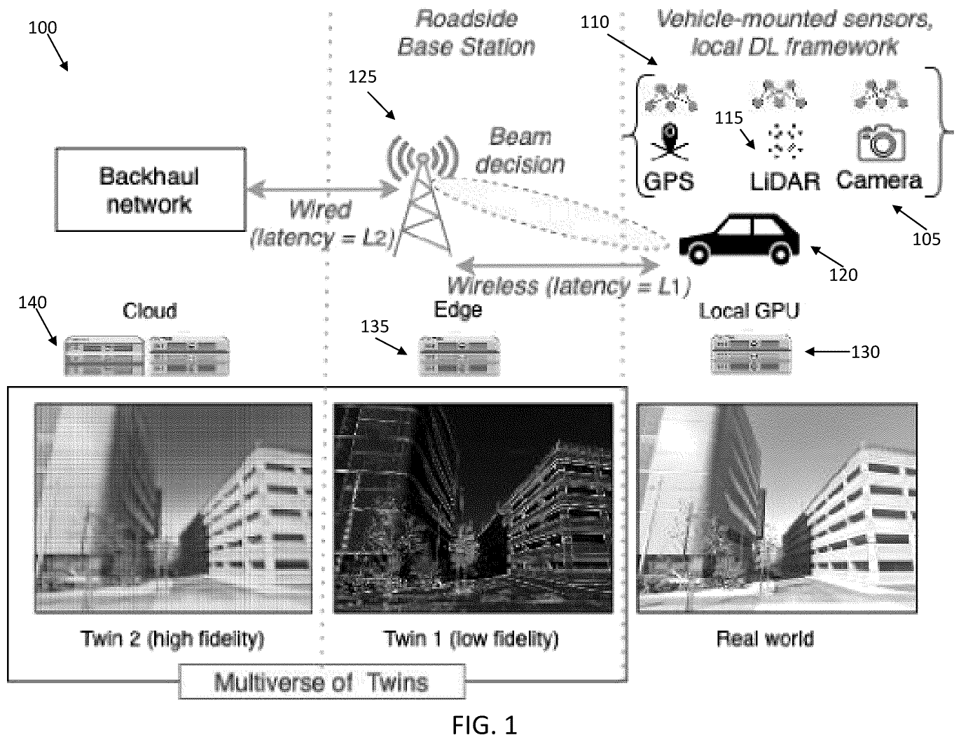

As shown in FIG. 1, the system 100 involves selecting one of several directional beams in the millimeter-wave (mmWave) band to establish connectivity between an autonomous car 120 and a roadside base station (BS) 125. Vehicle-mounted sensors, e.g., camera 105, GPS 110, and LiDAR 115 are used to obtain contextual information about the environment. Recent works have studied deep learning (DL) models, namely, convolutional neural networks (CNNs), deployed on the vehicle. These models fuse available multimodal sensor data (e.g., camera 105, GPS 110, LiDAR 115) and predict the best beam at the vehicle and the BS. This considerably shortens the time involved in an exhaustive sweeping from probing all beam directions, by 52.75% and 95% compared to the conventional exhaustive-sweeping approach defined in the 802.11ad and 5G-NR standards, respectively. However, a challenge arises when the DL model needs to perform in new or altered environments that it has not encountered previously during training. Examples of the new or altered environments may be a new street or a temporary, large obstruction not seen during training. Such situations result in unpredictable wireless propagation conditions that cannot be fully characterized without new RF information.

Nevertheless, a fundamental question in these benefits is whether the added latency of augmenting DL via digital twin predictions can remain low. The latency and fidelity depend on whether the vehicle accesses a local GPU accelerator component 130, commercial grade GPUs at the base station (edge server 135), or a GPU farm at the cloud layer 140, of the system 100 and as shown in FIG. 1.

Computational resources thus determine the accuracy in emulating ‘reality’, and latency to these resources determines how much time a twin devotes to returning actionable insights. The ‘multiverse’ paradigm is apt for exploring this accuracy-latency tradeoff via twin selection: different twins with varying levels of fidelity and emulation quality are available, depending on computing resources. Thus, the challenge that arises is identifying which twin to invoke within the multiverse at any given time. Ultimately, the prediction of the twin must be timely (i.e., the vehicle can use its prediction before it speeds away) and accurate (i.e., close to exhaustive search quality).

The present multiverse of twins does not completely replace DL-based beam predictions. Rather, one of the twins in the multiverse is invoked only when a major environment change is detected. As shown in FIG. 1, if the vehicle can predict the beam locally for beam selection using the onboard GPU 130, then there is no need to invoke any twin in the multiverse. In turn, the twin's beam recommendations, obtained through ray-tracing, not only identify the best beam for the current scenario, but can also generate a labeled data point for continuous learning for the DL models at the vehicle.

The multiverse is composed of three digital twins. The vehicle uses its on-board camera images in combination with local deep learning to detect an environment change (for e.g., a blockage of certain dimensions that was not seen earlier). Upon triggering multiverse, if the new unseen environment is already included in multiverse of twin, the pre-generated look up tables are sent in the downlink for all twins. These look up tables include information about the locations of the receiver and signal-to-noise-ratio (SNR) of all beams obtained by ray tracing tool. A decision framework at vehicle then identifies (a) which of the twins in the multiverse must be used, and (b) what is the optimum subset of beam for the selected twin, according to the user defined communication and computation costs. The candidate top-K beams are then swept by the receiver to identify the optimum beam and start the transmission. If the unseen environment is not included in multiverse of twins, then the vehicle relays the sensor data to setup a virtual scenario in the ray tracing tool Wireless InSite that may be deployed at the cloud. This scenario models the actual geographical location of the car, dimension and placement of the obstacles, twin-specific detailed antenna models and multipath emulation settings. At the end of this step, the lookup table of the unseen environment is added to the multiverse of twins to be used by upcoming vehicles later. Clearly, the main challenge involves (i) correctly detecting the change in environment locally (i.e., at the vehicle), (ii) choosing one of the three twins, (iii) ensuring the complete cycle of query-compute-response can be completed in less time than performing a local, exhaustive search.

### Traditional Beam Initialization

The 802.11ad and 5G-NR standards use exhaustive search during beamforming wherein the transmitter (Tx) sends out probe frames in all beams sequentially and the receiver (Rx) listens to these frames with a quasi-omni-directional antenna setting. This process is then repeated with the Tx-Rx roles reversed. Assume the Tx has a pre-defined codebook Cⁱ_{TX}={t1, . . . , tBi}, comprising Bi elements for i^{th} scenario, where each scenario corresponds to the Rx vehicle travelling at a different speed and/or in the presence of a different obstacle between it and the Tx. These Bi probe frames are transmitted for beam initialization and the beam with the maximum signal strength across all sectors is chosen as optimal. In particular, the optimal beam at Tx is:

$${t}_{i}^{*} = {arg min}_{1 \leq {b}_{i} \leq {ℬ}_{i}} {p}_{{t}_{{b}_{i}}} , \qquad ( 1 )$$

where pt_{bi} is the strength of the received signal at the Rx when the transmitter uses beam tbi for the i^{th} scenario. While this method is effective at finding the optimal beam, exhaustively transmitting a linearly-scaling Bi probe frames is slow and impractical within a vehicle-to-everything (V2X) network, particularly when considering a large number of possible beams and transmission time. By the time the optimal beam is found, the vehicle may have moved into a new environment where either a different number of beams are available or the optimal beam is no longer available, requiring the selection process to be reinitialized.

### ML-based Beam Selection

To avoid the costly exhaustive search in traditional beam selection, as a starting point the methods, such as DL models to predict the best beam based on fusing non-RF multimodal data, such as LiDAR, camera images and GPS coordinates. Prior to model deployment, a training set of labeled inputs from η different scenarios may be accessed. Training data corresponding to the i^{th} scenario is given by Sᵢ:={(X_{i,j}^{L}, X_{i,j}^{I}, X_{i,j}^{C},)}_{j∈n}_{ᵢ}, where each X_{i,j}^{L}, X_{i,j}^{I}, X_{i,j}^{C} are LiDAR, image, and GPS coordinate samples and Y_{i,j}∈{0, 1}^{B}^{ᵢ} is its corresponding label, and j is indexed over the number of samples nᵢ from the i^{th} scenario. The learning model is a function ƒ_{θ}= [symbol] ^{d} [symbol] [symbol] ^{B}^{ᵢ}, parameterized by θ, e.g. ƒ_{θ} may be a neural network with weights θ. The empirical loss of the model parameters θ on dataset for scenario Sᵢ is defined as

$$ℒ ( θ ; {S}_{i} ) := \frac{1}{{n}_{i}} {\sum }_{j = 1}^{{n}_{i}} [ ℓ ( {f}_{θ} ( {X}_{i , j}^{L} , {X}_{i , j}^{I} , {X}_{i , j}^{C} ) , {y}_{i , j} ) ] ,$$

where [symbol] : [symbol] ^{B}^{ᵢ}×{0,1}^{B}^{ᵢ}→ [symbol] ⁺ is a loss function measuring the discrepancy between predicted and true labels, cross entropy for example. The standard ML training approach finds a model that minimizes the average loss across all of the training samples by solving:

$${min}_{θ ∈ {ℝ}^{D}} L ( θ ) := \frac{1}{U} {\sum }_{i = 1}^{η} {n}_{i} L ( θ ; {S}_{i} ) ,$$

$$where U = {\sum }_{i = 1}^{η} {n}_{i} .$$

After the model training, the best beam for m^{th} scenario Sₘ is predicted as:

$${t}_{m}^{′} = σ ( {f}_{θ} ( {X}_{m}^{L} , {X}_{m}^{I} , {X}_{m}^{C} ) ) , \qquad ( 2 )$$

where σ denotes the softmax activation, Xₘ^{L}, Xₘ^{I}, and Xₘ^{C} are one sample from LiDAR, image and coordinate sensors, respectively.

### Beam Selection in Unseen Scenarios

In practical applications of V2X networks, when new scenarios are encountered during deployment phase that were not seen during training, the predicted beams may be erroneous. Although it may be assumed that the model does not have enough data or computational budget to perform fully supervised learning in the new scenario, there are few possible solutions: The model could be provided with a few labeled samples for model fine-tuning. Such assumptions are the basis of applying meta-cognition based learning algorithms such as model agnostic meta learning and task-robust meta learning. However, in practical applications, high speed vehicles may only be within a communication range of a mmWave Tx for a few seconds and new labeled data acquisition will require exhaustive beam search. Hence, the techniques and methods described herein provpose an interactive multiverse-based solution, where the vehicle: (a) recognizes the change in the environment within a few ms time with high precision; (b) invokes a twin in the multiverse for beam prediction, preferably in μs time scale.

### Invoking a Twin in the Multiverse

Consider S_{η+1}, . . . , S_{η+ν} as the unseen scenarios. One sample is denoted from one such scenario Sₘ as :={(Xₘ^{L}, Xₘ^{I}, Xₘ^{C})}, where η+1≤m≤η+ν, and Xₘ^{L}, Xₘ^{I}, Xₘ^{C}∈ [symbol] ^{d} are LiDAR, image, and GPS coordinate samples. The scene change detection component is represented as γ(·), which follows the outlier detection method that may use the captured image as Xₘ^{I}. The best beam for one sample of unseen scenario Sₘ is predicted as:

$${t}_{m}^{′} = \{ \begin{matrix}σ ( {f}_{θ} ( {X}_{m}^{L} , {X}_{m}^{I} , {X}_{m}^{C} ) ) & if γ ( {X}_{i}^{I} ) = {D}_{ID} \\ ℳ ( {C}_{Comp} , {X}_{m}^{C} ) & if γ ( {X}_{i}^{I} ) = {D}_{OOD}\end{matrix} \qquad ( 3 )$$

where σ denotes softmax activation, M is the created multiverse comprising multiple twins with C_{Comp} computation cost constraint, D_{ID} implies that the data sample belongs to the training environment (in-distribution) and D_{OOD} denotes that γ(·) has identified that the captured image is out-of-distribution (OOD). The γ(·) performs a thresholding operation that determines whether to call a previously trained DL model on board the vehicle or invoke a twin in the multiverse.

### System Model

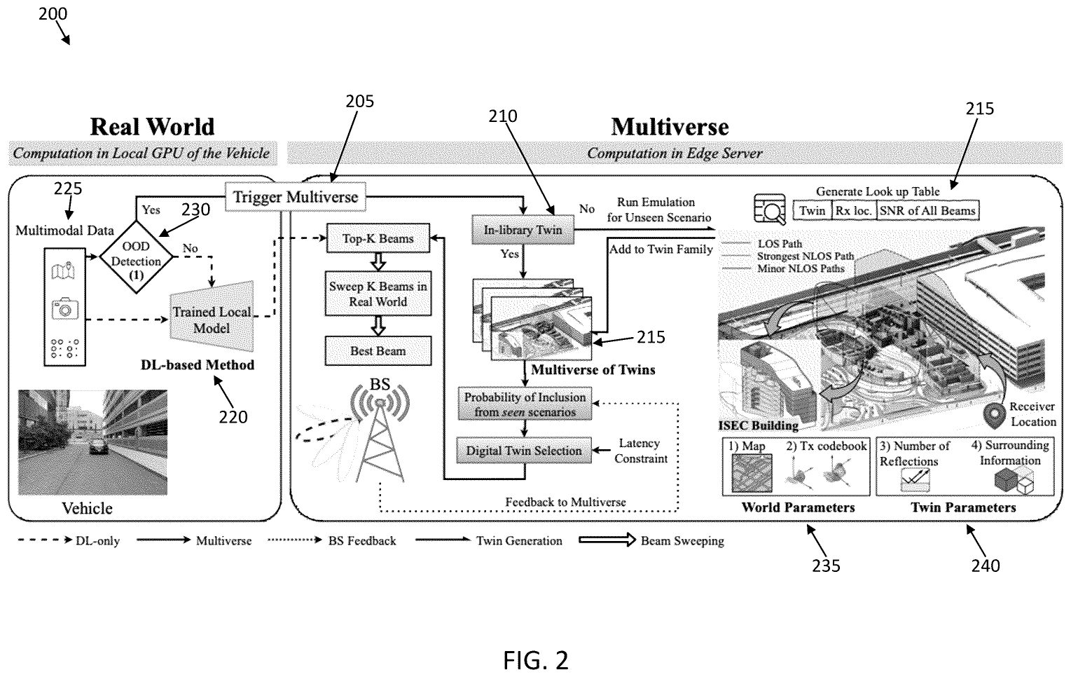

The methods and techniques described herein propose a multiverse-based beam selection approach, as shown in FIG. 2. The framework revolves around (i) creating a multiverse of twins in the edge server 135 of base station 125 (BS) through the edge cloud 140, and (ii) interacting with the multiverse from real world through the local GPU 130 of the vehicles. The trigger multiverse component 205 calls for the multiverse M 215 from the edge, following Eq. 3. The edge has a few in-library twins 210 within M which are downloaded from the cloud server of the backhaul network through a multi-Gbps wired connection. This includes the twins that are encountered before and are already available at the edge. If the requested twin from the vehicle is already available at the edge, a look up table with information about the locations of the receiver and SNR of all beams are sent in the downlink through a multi-Mbps sub-6 GHz wireless control channel. The vehicle then exploits this lookup table to jointly optimize the selection of twin and associated top-K beam candidates. If the requested twin is not available at the edge, the sensor data of the vehicle is sent in uplink to the cloud 140, where the ray tracing tool runs to generate a look up table for the new unseen environment. The output look up table is added to twin family in Multiverse 215. Note that if the requested twin is already available at the edge, the Multiverse provides an output in competitive time compared to exhaustive search. If not, the computationally extensive ray tracing must be run at cloud which might not provide an output in short contact times in vehicular network. However, the simulation output can be later be used to account for the new vehicles as they encounter the same environment.

FIG. 2 illustrates a process 200 for using a multiverse of twins to determine beam selection based on a change in environment for the autonomous automobile 120. The methods and techniques described herein may be used to in part to train a machine-learning model such that the system 100 may actuate in unseen or changed environments and determine potential beam directions for the autonomous vehicle in the present environment. A dataset of twins may be generated for training the machine-learning models. The machine-learning models may be trained to select an appropriate twin for a particular scenario (e.g., environment), based on factors such as latency, accuracy, and other requirements. The methods and techniques described herein rely on both the generation and use of multiple twins (e.g., multiverse of twins) as well as the multimodal (e.g., images, GPS, LiDAR) data used for the generation of the twins at a particular location.

A digital twin may be considered a representation of a real-world environment in the virtual domain. Digital twins may have varying levels of fidelity, where fidelity corresponds to the level of detail and information stored with the digital twin. The fidelity may correspond to a level of definition of the captured images of the environment (e.g., low resolution, high resolution), as well as information corresponding to objects in the environment, such as identifying objects like trees, buildings, and signs. Additionally, further details may correspond to the composition of objects, such as materials of a building (e.g., brick, glass). The fidelity may correspond to the beam directional information stored with twin, such as the number of beam directions, as well as reflection information for the beam directions (e.g., one reflection, three reflections).

For a particular twin, the one or more beam directions may be determined using a neural network. In some embodiments, the beam direction may be determined base don an individual modality (e.g., image, LiDAR). In some embodiments, features may be extracted from the penultimate layers of each modalities individual neural network and then processed together to determine one wholistic inference. The neural network may be used to determine the best beam direction or a set of the top K beam directions (e.g., 5, 10, 20) that are then used by transmitter of the autonomous vehicle to identify the strongest signal strength.

As shown in FIG. 2, a lookup table 215 maybe generated that that includes a twin, the location of a receiver (e.g., GPS coordinates), and SNR data for beam directions corresponding to the particular receiver. The cloud system 140 may initially generate twin datasets for various receiver locations. A twin is a dataset created for predicting what the vehicle should do (e.g., beam direction) to best communicate with a base station 125. The twins may be generated using world parameters 235 (e.g., maps, GPS, transmission codebooks) and twin parameters 240 (e.g., number of reflections, surrounding environmental information). As previously described, a twin may include beam direction data and may capture the reflections from the environment. In some instances, the twin may not include data for any reflections (e.g., zero reflections) and thus may use only LOS. In other instances the twin may include data for a range of reflections (e.g., 1, 3, 10). The twin data may include other obstructions, such as the number of trees, and environmental information, such as the material of a building's surface. These factors contributes to the complexity of the twin and thus determine the fidelity of the twin. The cloud system 140 may generate twins with combinations of these factors that result in multiple twins of different levels of fidelity for a particular location. Given the different fidelity of the twins, processing time for a twin is proportional to the complexity of the twin. Thus, the fidelity corresponds to quick and coarse accuracy or time consuming and more precise accuracy.

The twin data, including a corresponding lookup table 215, may be deployed to edge servers 135. For example, an edge server that corresponds to a particular physical location may receive twin data corresponding to the base stations 125 located within that particular physical location. The edge server 135 may send the twin data an autonomous vehicle when the vehicle is within the particular physical location.

The autonomous vehicle may collect multimodal data 225 from various sensor (e.g., camera, GPS, LiDAR) as the vehicle travels. The local GPU 130 of the vehicle may use the multimodal data 225 to perform OOD detection 230. The local GPU 130 may perform OOD detection 230 by comparing the multimodal data 225 (i.e., the current surrounding of the vehicle, live conditions of the road) to the sample images from the twin data for the particular location. If the OOD detection 230 determines that the multimodal data 225 is similar to the sample images from the twin data, such as determining the differences are within a threshold value, then vehicle will use the stored twin data. The local GPU 130 may use the stored twin data to make a selection of beams to sweep through one by one. The number of beams selected for the sweep may be based on a predefined setting to make this selection for how many beams to choose that is sweeps through individually. The number is a setting. It then sweeps those beams to find the best one.

The trained local model 220 may be trained using twin data to determine the one or more beam directions (e.g., top K beams) for particular input multimodal data. If the local GPU 130 determines that there is no OOD detection 230, or, as described below, a corresponding twin is not identified in the multiverse of twins, then the multimodal data 225 may be input to the trained local model 220. Using the multimodal data 225 of the present surroundings (e.g., current environment), the trained local model 220 may determine one or more beam directions. In some embodiments, the vehicle may send the one or more beam directions to the edge server 135 to determine the best beam. In some embodiments, the local GPU 130 of the vehicle may determine the best beam from the results of the trained local model 220.

If the OOD detection 230 determines that the multimodal data 225 is not similar to the sample images from the twin data, such as determining the differences exceed a threshold value, then the local GPU 130 may activate the trigger multiverse component 205. The trigger multiverse component 205 may request, from the edge server 135, beam information for the best beam direction to use for communicating with a particular base station 125.

The edge server 135, upon receiving the request from the trigger multiverse component 205, may determine if twin data corresponding to the current multimodal data 225 (i.e., data different from the vehicle's twin data) is in the twin library (e.g., multiverse of twins) by identifying twins corresponding to the location using the look up table 215. If the edge server 135 determines that the multiverse of twins does not include an entry corresponding to the multimodal data 225 (e.g., a new obstruction), then the edge server 135 may request the cloud server 140 to run an emulation and generate new twin data based on the multimodal data 225 provided by the local GPU 130 (e.g., the autonomous vehicle). The new twin data may be generated and added to the multiverse of twins at a later point in time for future use. Based on the multiverse of twins not including an entry corresponding to the multimodal data 225, an indication may be sent to the local GPU 130 to use the trained local model 220, as described above.

If the edge server 135 determines that the multiverse of twins does include an entry corresponding to the multimodal data 225 (e.g., a new obstruction), then one or more twins may be selected from the multiverse of twins that correspond to the multimodal data 225. Selecting the best twin from the multiverse of twins that corresponds to the multimodal data 225 may be based on optimization that includes factors such as latency, the location of the receiver, and the fidelity of the twin. The fidelity of the twin may affect the processing time required for determining the best beam. The optimization is described in detail below in reference to Digital Twin Selection. The selected one or more twins include beam direction data that may then be used by the edge server 135 to select the best beam.

In some embodiments, beam selection may be performed at the vehicle by the local GPU 130. In other embodiments, beam selection may be performed by the edger server 135 and the result transmitted back to the vehicle. The top K beams may for a particular location may be identified by either the trained local model 220 or as indicated by the digital twin selected which corresponds to multimodal data 225. If the top K beams includes one beam, then the beam direction data is provided to the vehicle for communicating with the base station 125 (e.g., receiver). If the top K beams includes more than one beam, then a sweep in the environment (e.g., real-world) may be performed using each beam of the top K beams to determine the best beam (i.e., the strongest beam with the highest SNR). The determined beam direction data corresponding to the determined best beam may be provided to the vehicle for communicating with the base station 125 (e.g., receiver).

The working principle of different components of the system model is detailed below under Multiverse-Based Beam Selection. The overall solution has three main thrusts. First, Offline Multiverse Creation, that uses twins with different fidelities, creates a multiverse at the edge which is distributed across different compute resources as described below. After this offline creation step, a lookup table is generated containing the associated performance and cost of querying different twins. Second, Real-time Multiverse Interactions, where in an unseen scenario, the vehicle detects changes in the environment through the multimodal data of camera and LiDAR, and interacts with the multiverse for fast beam prediction on their local GPU, as discussed below. Third, Real-world Augmentation, that uses the predicted beams from the multiverse in an unseen environment as labeled data, the trained local model is updated for an improved performance.

### Multiverse-Based Beam Selection

### Offline Multiverse Creation

The offline multiverse creation may comprise three steps: (a) twin world creation, (b) modeling the propagation paths, (c) creation of lookup table. The multiverse is created through a centralized coordinator, with the twins installed on the different compute resources at the edge. The generated lookup table is downloaded to the local processing unit of the vehicle, suppose at a local GPU, whenever it enters within the communication range of the BS.

Twin-world creation: The multiverse may be defined as a collection of N digital twins, represented as [symbol] ={ [symbol] , . . . , [symbol] }. Each twin exhibits different properties with respect to map precision, transmitter codebook, mmWave propagation properties. While several key metrics may be considered to formulate different digital twins in the multiverse, the baseline can be extended in the future to twins that also incorporate weather patterns such as the effect of rain/snow. A twin [symbol] is initialized as a function of imported maps, dimensions of the surroundings, transmitter codebook, number of allowed reflections: [symbol] =ƒ_{twin}(mapᵢ, Oᵢ, C_{TX}ⁱ, ρ), where the

$${O}_{i} = {\{ ( {x}_{j} , {y}_{j} , {h}_{j} , {w}_{j} ) \}}_{j = 1}^{{N}_{i}^{obs}} ,$$

Nᵢ^{obs} is the number of structions or obstacles in the digital world and (xⱼ, yⱼ), hⱼ, wⱼ, are the relative position, height and width of the different obstacles; ρ is the number of reflections, mapᵢ is the imported maps within the digital world. Depending on the desired fidelity of [symbol] , the precision of the mapᵢ is determined.

Modeling the propagation paths within the twins: To model the propagation paths in twin [symbol] for scenario Sᵤ (where 1≤u≤η), the Rx is placed at [symbol] different locations, where mmWave signals may be sent out with ρᵢ reflections for each location. The propagation study may be performed for each of the Tx codebook element or beam tₘ (where 1≤m≤ [symbol] ᵤ) from each of those locations in Sᵤ, denoted as Iⱼⁱ (where 1≤j≤ [symbol] ). Varied propagation paths may be obtained for different Tx beams at each location. The upper bound of all the possible paths may be derived with ρᵢ reflections and single allowed diffraction (ζ=1) at location Iⱼⁱ as:

$${N}_{{l}_{j}^{i}}^{{ρ}_{i}} = {N}_{{l}_{j}^{i}}^{{ρ}_{i} - 1} + ( {ρ}_{i} + 2 ) , where {N}_{{l}_{j}^{i}}^{0} = 1.$$

Hence, theoretically,

$${N}_{{l}_{j}^{i}}^{{ρ}_{i}}$$

is invariant to the properties of Tx beam tₘ. However, in practice, the actual number of total propagation paths depends on the properties of tₘ and the surrounding environment. X3D may be used for modeling the mmWave propagation path. The received power at location Iⱼⁱ for the Tx beam tₘ is denoted as pⱼ^{m}. For calculating the received power at Rx, the phase information of rays are considered. Accordingly, the coherent power calculation at Rx is used in Eq. 4.

$${p}_{j}^{m} = \frac{{λ}^{2} β}{8 {πη}_{0}} {\vert {\sum }_{i = 1}^{{N}_{p}} [ {E}_{θ , i} {g}_{θ} ( {θ}_{i} , {ϕ}_{i} ) + {E}_{ϕ , i} {g}_{ϕ} ( {θ}_{i} , {ϕ}_{i} ) \vert}^{2} , \qquad ( 4 )$$

where Nₚ is the number or rays delivered at Rx, λ is the wavelength, β is the overlap of the frequency spectrum of the transmitted waveform S_{T}(ƒ), and the spectrum of the frequence sensitivity of the receiver S_{R} (ƒ), η₀ is the impedance of free space (377Ω), θᵢ and ϕᵢ represent direction of arrivals, E_{θ,i} and E_{ϕ, i} are the theta and phi components of the electric field of the i^{th} path at the receiver point. Further, g_{ϕ}(θ, ϕ)=\sqrt{|G_{θ}(θ, ϕ)|}e^{jψθ}, where G_{θ} is the theta component of the receiver antenna gain and ψ_{θ} is the relative phase of the θ component of the far zone electric field. Once the received power is determined (in Watts), the power in dBm is calculated using pⱼ^{m}(dBm)=10 log₁₀[pⱼ^{m}(W)]+30 dB−Lₛ(dB), where Lₛ is any loss in the system other than path loss.

The maximum received powers may be retrieved for all [symbol] ᵤ beams from scenario Sᵤ at the Tx of twin Tᵢ from the dominant propagation path at the Iⱼⁱ location using:

$${P}_{j}^{i} = {\{ max {\{ {p}_{n}^{a} \}}_{n = 1}^{{N}_{{l}_{j}^{i}}^{{ρ}_{i}}} \}}_{a = 1}^{{ℬ}_{u}} ,$$

where p corresponds to the received power, and P is an array of p comprising [symbol] ᵤ elements. The SNR values may be calculated for all the [symbol] ᵤ beams at each location lⱼⁱ in SNRⱼⁱ=Pⱼⁱ− [symbol] ⱼⁱ, where |SNRⱼⁱ|= [symbol] ᵤ, and [symbol] ⱼⁱ is the noise power in dBm at location lⱼⁱ for [symbol] .

Cost per twin creation: Querying a twin [symbol] has an associated computation cost that is the sum of: (a) cost of generating the world, (b) cost of the generating propagation paths of all locations for creating a lookup table. Thus, the total cost for creating a twin:

$${C}_{Comp}^{{𝒯}_{i}} = {C}_{map}^{{𝒯}_{i}} + {C}_{lookup}^{{𝒯}_{i}} , \qquad ( 5 )$$

where [symbol] is the cost to generate/import the maps for creating the world, and [symbol] is the cost to run simulations to generate the lookup table, which is further broken down as

$${C}_{lookup}^{{𝒥}_{i}} = {N}_{{l}_{j}^{i}}^{{ρ}_{i}} \times {L}_{i}^{𝒥} \times {C}_{prop} ( ρ ) , {C}_{prop} ( ρ )$$

being the cost for calculating one propagation path with ρ reflections. Following a standard, Cₚᵣₒₚ(ρ) is characterized as:

$${C}_{prop} ( ρ ) = \frac{( ρ + ι + 1 ) !}{ι ! ρ !} , \qquad ( 6 )$$

With ρ denoting the number of reflections, and t being the number of transmissions through walls. Overall, these costs can be formulated w.r.t. either time or computation resources.

Creation of lookup table: After modeling all the propagation paths for different Rx location in each twin, a lookup table may be created with the information from all the twins. Each tuple of the lookup table comprises four parameters: (a) Rx location index lⱼⁱ, (b) Twin index [symbol] , (c) SNR values SNRⱼⁱ for all the [symbol] ᵤ beams of scenario Sᵤ for location lⱼⁱ in the [symbol] , hence represented as a dictionary: LT( [symbol] )⊆{(lⱼⁱ, [symbol] , SNRⱼⁱ, [symbol] )}.

### Real-Time Multiverse Interaction

When a vehicle comes within a range of multiverse-enabled mmWave base station (BS) or access point (AP), it downloads: (a) a trained DL model that can utilize multimodal sensor data, and (b) the multiverse lookup table from the edge. The vehicle thus can use the DL models previously designed for ML-aided beam selection by leveraging the collected LiDAR, camera and GPS data (e.g., multimodal data). The vehicle may choose to use the existing trained model or query the multiverse via the lookup table depending on the detected change in the environment.

Scene change detection: The first step of interacting with multiverse may include detecting changes in the environment from the camera images mounted on the vehicle. A number of sophisticated state-of-the-art techniques exist for this. Previous works may focus on using statistical techniques like computing prediction probability and correctness ratio averaged over a large number of input sequences and identifying outliers using a pre-determined threshold from the training set. However, in this scenario it is beneficial to avoid processing a large number of input images to ensure real-time performance with limited computational resources. A generative adversarial network (GAN) may be used, leveraging the benefits of generative deep learning, to rigorously learn to distinguish between in-distribution _{(D}_{ᵢₙ₎} and out-of-distribution (Dout) samples, followed by a simple classifier which computes the class-conditioned Gaussian distributions as a bottleneck vector. During inference, the change detection component passes γ(·) (from Eq. 3) captured image Xᵢ^{I} to the classifier to obtain its logit vector which is compared with the previously learnt class distribution vector using a distance metric like Cosine Similarity or Mahalanobis distance and classifies it as Din ^{or} Dout through an empirically determined threshold. This method has been validated to show a detection accuracy of 89.61% on the KITTI dataset. However, due to the unavailability of inference time analysis, instead methods where the outlier detection time analysis is performed on images, yielding to inference time of 1.71 ms-7.5 ms on GPU enabled computing platforms. If the vehicle detects a change in the environment, it activates the step of multiverse interaction, otherwise, it continues inference from the pre-existing trained DL model.

GPS coordinate correction: Due to the limitation of errors in GPS data from the real world, a correction of GPS location may be performed, denoted as G(·). The real-time GPS coordinate of the vehicle is represented as: (x, y). The G(·) function eventually maps this (x, y) coordinate to one of the locations within each twin. Hence for N twins, there may be N such projected locations. To generalize, the mapped location is formulated for Tᵢ as: (xᵢ,yᵢ)= [symbol] (x,y, [symbol] ), where (xᵢ,yᵢ)∈ [symbol] . This correction is tuned to the specific multiverse and real world.

Lookup table consultation: Once the corrected GPS coordinate (xᵢ, yᵢ) is mapped to the location lⱼⁱ (where 1≤j≤ [symbol] ) within twin [symbol] , the vehicle searches the lookup table LT( [symbol] ) for solving the optimization problem stated in Eq. 8.

Digital twin selection: Recall that each of the twins { [symbol] }ᵢ₌₁^{N} offer different levels of fidelity and computation cost. Moreover, the communication constraints for each query is vehicle-specific. To account for such constraints, an algorithm is proposed to jointly optimize the selection of twins and associated top-K beam candidates.

Modeling fidelity (probability of inclusion): A simple way to model the fidelity of each twin is by benchmarking the performance of each twin with respect to the ground-truth from real world measurements. These observations indicate that the probability of inclusion for each twin is related to the sub-regions in the coverage area of the transmitter. Moreover, it is affected by the number of allowed beams K. To that end, the empirical observations are leveraged to model the success rate of each twin as p(K, LT ( [symbol] ), Sᵢ, r) where parameters K, LT ( [symbol] ), Sᵢ, and r denote that number of selected beams, set of lookup table entries for twin [symbol] , current scenario and the region in which the receiver is located, respectively.

Communication and computation costs: Once the subset of K beams is obtained from multiverse, it is sent back to the Rx i.e., the vehicle. The Rx then sweeps only the K beams instead of all [symbol] ᵢ beams. A 5G-NR standard may be used to model the communication cost for sweeping the top-K beams as:

$${C}^{5 G - NR} ( K ) = {T}_{p} \times [ \frac{K - 1}{32} ] + {T}_{ssb} , \qquad ( 7 )$$

Here, Tₚ=20 ms and T_{ssb}=5 ms correspond to the periodicity and synchronization signals (SS) burst duration that are used for sweeping K beams, respectively.

On the other hand, the computation time is a function of computation power for a given twin within the multiverse. The computation cost [symbol] for Tᵢ is retrieved by querying the lookup table LT( [symbol] ).

Optimization: The following optimization problem may be solved to determine the optimum twin and corresponding K as:

$$\begin{matrix}max \\ K , {𝒯}_{i}\end{matrix} p ( K , LT ( {𝒯}_{i} ) , {S}_{i} , r ) + \frac{α}{2} ( 1 - \frac{{C}^{5 G - NR} ( K )}{{C}_{Comm}} ) ( 1 - \frac{{C}_{Comp}^{{𝒯}_{i}}}{{C}_{Comp}} ) , \qquad ( 8 a )$$

$$s . t . {C}^{5 G - NR} ( K ) < {C}_{Comm} , \qquad ( 8 b )$$

$${C}_{Comp}^{{𝒯}_{i}} < {C}_{Comp} , \qquad ( 8 c )$$

$${r}^{b} \leq r \leq {r}^{e} , \qquad ( 8 d )$$

$${S}_{i} ∈ S , \qquad ( 8 e )$$

$$α > 0. \qquad ( 8 f )$$

In Eq. 8, the first term in objective forces the optimization problem to choose twins with higher fidelity (probability of inclusion). As opposed to this, the second term prevents the selection of unnecessarily high K values and more complex twins for time sensitive applications. The control parameter α in Eq. 8 weights the importance between these two terms in the objective function. Moreover, the parameters CComm and CComp are user defined constraints for selecting the best twin and associated K for the desired application. The computational complexity for running this optimization is in the order of O(N) with N denoting the number of twins.

Sweep K beams in real-world: After solving the Eq. 8, the optimum twin, denoted by Tm, and the associated top-K beams are determined. The vehicle then sweeps through those suggested top-K beams by multiverse for Tm in the real-world radios, obtains the optimum beam, and starts the transmission.

### Augmenting the Real-world

When the vehicle uses its local DL models for beam selection, the local multimodal sensor data is used for inference. This results in near-real time prediction of the beam due to locality of all actions. However, pure machine learning-based methods suffer from the adaptation to unseen environments which undermines the accuracy of the model prediction. Once a twin within the multiverse is invoked to obtain the optimal beam, the ray tracing based predictions become the ground-truth labels and then communicated back to the real world. This label is then synchronized with the local sensor data at the vehicle to retrain the local model periodically. As a result, the local model can account for the previously unseen environment locally, instead of continuous triggering of twins from the multiverse.

The fine-tuned model parameters θ is obtained by minimizing the loss C(\hat{θ}; Sₘ) on the unseen scenario

$${S}_{m} , where C ( \hat{θ} ; {S}_{m} ) := \frac{1}{{n}_{m}} {\sum }_{j = 1}^{{n}_{m}} [ ℓ ( {f}_{\hat{θ}} ( {X}_{m , j}^{L} , {X}_{m , j}^{I} , {X}_{m , j}^{C} ) , {y}_{m , j}^{{𝒯}_{i}} ) ] ,$$

where nₘ is the number of samples for augmentation from Sₘ, [symbol] are the predicted labels from twin [symbol] for Sₘ.

### Experiment Design

The real-world may be a V2X scenario in an urban canyon setting within a metro city. The digital multiverse is designed within a ray-tracing simulation platform, such as Wireless InSite (WI) by RemCom. WI is capable of modeling efficient and accurate predictions of electromagnetic propagation and communication channel characteristics in complex 3-dimensional (3D) urban, indoor, rural and mixed path environments.

### Real-world: Creation of Ground Truth

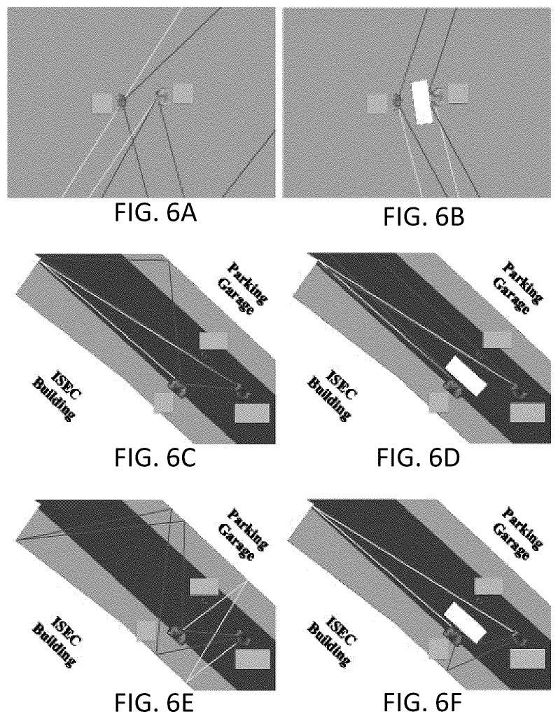

A publicly available mmWave beam selection dataset called FLASH may be used to generate the ground truth from the real-world. FLASH may be a dataset that is collected from different modalities such as GPS, camera, and LiDAR, as well as the RF (Radio Frequency) data. The FLASH dataset may correspond to a vehicular network, such as a base station tower that connects to a vehicle). The FLASH dataset may be used for validation. The FLASH dataset was captured within downtown Boston on a road flanked with high rising buildings using mmWave band communication signals. This dataset includes synchronized sensor data from on-board GPS, a GoPro Hero4 camera, and a Velodyne LiDAR, all mounted on a 2017 Lincoln MKZ Hybrid autonomous car. The ground-truth on signal strength per beam was acquired using a Talon AD7200 mmWave radio. The received signal strength indicator (RSSI) and SNR may be measured for all 34 valid beams, which are then synchronized in time with the multimodal data. The dataset includes both LOS (denoted as S1) and NLOS (denoted as S2) scenarios with approximately 5K and 3K samples for each, respectively. The number of valid beams in both S1 and S2 is 34, i.e., B1=B2=34. S1 is the case where the vehicle is in front of the Tx without any obstacle, while in S2, another vehicle is located in front of the Tx, as shown in FIGS. 6D and 6F.

### Multiverse Setup in Wireless InSite

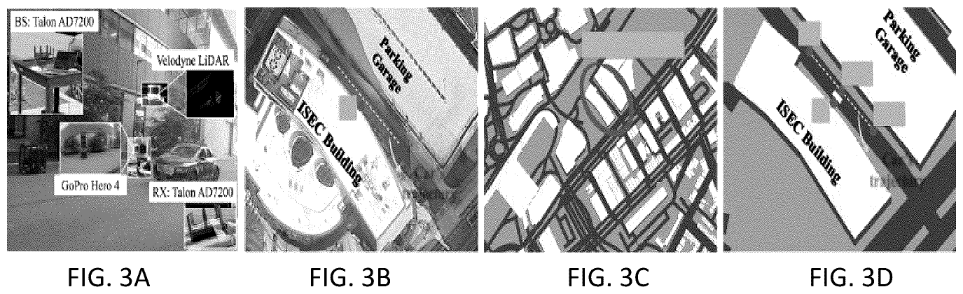

The chosen simulation platform WI allows users to create a realistic environment with 3D maps, including, buildings, roads, water-bodies, and foliage. Users have options to change material types, e.g., concrete for buildings or asphalt for roads. As the real-world represents an urban canyon setting, i.e., on an asphalt road between two high rising buildings in Boston, the virtual world may be created at the same location, using the closest materials and coordinates. A sample map visual for the virtual world is provided in FIG. 3.

Twin-world creation: For an mmWave V2X network setup, even small variations in creating a digital twin may impact the outcome dramatically. The first step in creating a twin is to obtain an appropriate map, layers for buildings and foliage. OpenStreetMaps may provide such data, which may be processed to access geodata for WI. The road and valley width as well as building dimensions in the virtual world match with the ones in the real world.

Placement of obstacles and infrastructure: In WI, a virtual world can have various features, which are stored as layers, e.g., buildings, roads, water bodies. Buildings and obstacles are modeled as boxes that can have different material features, e.g., concrete, glass, metal, providing realistic ray reflection and penetration. The 3D dimensions and coordinates for obstacles can be set as desired.

Placement of Tx and Rx: Following the real-world, the Tx antenna of twin's digital world is placed on a cart with the height of 75 cm. The mounted Tx height is 20 cm. Thus, the Tx height is set to be 95 cm in the twins. The car used in the FLASH dataset has a height of 147.5 cm. Thus, the Rx height is set to be 167.5 cm cm in the simulation environment. In each twin simulation, there may be one Tx location and one or more Rx locations (denoted as L^{T}, for [symbol] ) following the S1 and S2 scenarios of real-world experiments.

Selection of propagation model: WI provides a number of propagation models. Among these, X3D may be used because it provides high fidelity simulations, taking the following channel parameters into account: 3D ray-tracing, indoor-outdoor suitability, atmospheric attenuation (temperature, pressure, humidity), reflection angle dependent reflection coefficients, and MIMO system analysis. Computation-wise X3D uses GPU acceleration.

Designing the Tx and Rx antennas: The antenna patterns may be obtained by adapting their measurements into WI. The details may found below.

Selection of ρ, t, and ζ: WI also allows users to select ray spacing ω (angle between two adjacent emitted rays), maximum number of reflections ρ, maximum number of transmissions t, and maximum number of diffractions. Reflections ρ may be selected to be either 1 or 3, because it may be observed that given the geometry of the environment and the effect of reflections on the received power, this number of reflections is enough to deliver signals to the receivers. The t may be selected to be 0, because the data collection environment (urban canyon) is mostly concrete on the sides and the floor is asphalt and mmWave signals typically cannot penetrate through concrete walls. is set to be 1, because after 2 diffractions, mmWave signal strength is negligible. While analyzing the empirical computation costs for a single antenna run for different values of ρ, it may be observed that the increasing experiment runtime with increasing ρ, details are in Tab. I.

TABLE I
Computation time to run a single antenna experiment
on WI for different number of reflections, on a
computer with Intel i9 processor with 32GB RAM.

| ρ | 1 | 3 | 5 | 7 | 10 |
|---|---|---|---|---|---|
| Time (s) | 10 | 18 | 32 | 45 | 55 |

| | |
|---|---|
| CPU usage | 21% initial peak then constant 17% |

Ray tracing in Wireless InSite: In WI, ray tracing experiments may be performed for each Rx location in each scenario per twin for each of the 34 Tx beams. During each experiment, the angle between two rays is set to a specific value and rays are transmitted at all directions in the Euclidean space following the antenna pattern specifications. In these twins, ray spacing may be selected to be ω=0.25°. Since the rays are emitted in discrete angles and they spread as they travel through space, it is not guaranteed that rays would be received at exact Rx locations. Thus, in order to ensure that received rays are correctly estimated, WI puts a sphere around the receiver point, with the radius r. Depending on how large that r is, several rays might pass through the sphere. There are two steps to identify which ray to select: i) rays are sorted according to the geometry faces they interact with and the similar ones are eliminated in order to prevent over-predicting the delivered energy at the receiver, because these rays are essentially the same, and then ii) the closest ray to the actual Rx point is selected. (ω=0.25° yields r=8.73 cm following the relation of ω=r

Dmax in the WI manual, where Dmax≈20 m in these twins (see Tab. II for details). What sets the X3D model apart from other models in WI is that it applies Exact Path Calculations (EPC), which adjusts the reflection and diffraction points so that the selected rays pass through the exact receiver points.

TABLE II
Virtual world parameters.

| | |
|---|---|
| Materials | Buildings: Concrete |
| | Road: Asphalt |
| | Foliage: Grass |
| Antenna orientation | Tₓ and Rₓ facing opposite directions |
| Waveform | f_{c} = 60 GHz, BW = 2.16 GHz |
| Tx power | 24 dBm [32] |
| Tx and Rx pattern source | Talon antenna measurements [33] |
| Tx height | On a cart, 0.95 m |
| Rx height | On a car, 1.645 m |
| P_{N} | −100.99 dBm |
| Antenna sensitivity | −250 dBm |
| Ray spacing | Δω = 0.25° |
| ζ | 1 |
| ι | 0 |
| Scenarios | S₁ & S₂ |

Parameter selection for twin creation: The multiverse [symbol] may be created with three twins with differences in cost and precision, i.e., [symbol] ={ [symbol] }. All twins have the same materials for the surrounding buildings and foliage, antenna orientations, transmitted waveforms, transmission power, Tx and Rx antenna patterns, coordinates for the Rx sample points, noise power, and antenna sensitivity. To create differences between twins, changes may be made to (i) environment used in the twin world, (ii) number of allowed reflections, p, in simulations, and (iii) number of Rx locations, [symbol] . The common parameters in the virtual world creation are given in Tab. II, whereas the differences between twins are given in Tab. III. The details of the different twins are provided in Secs. V-D to V-F, which are presented in the order of complexity.

Cost for creating the twins: The cost of creating [symbol] , and [symbol] is determined by Eq. 5. In Eq. 5, the [symbol] includes one-time cost for [symbol] : (i) finding appropriate maps, (ii) confirming building/object dimensions with their real life counterparts, (iii) antenna pattern design, (iv) precise antenna locations and heights, (v) obstacle locations and dimensions, (vi) selecting the most representative propagation model. It may be observed that [symbol] < [symbol] = [symbol] for [symbol] and [symbol] . On the other hand, [symbol] is an offline computation cost in order to create a lookup table for online use in different settings of the three twins. A Dell XPS computer with Intel i9 processor and 32 GB RAM is used to create a lookup table. The [symbol] for [symbol] and [symbol] are given in Tab. III.

TABLE III
Differences between twins.

| Twins | Baseline (T₁) | 1-Reflection (T₂) | 3-Reflection (T₃) |
|---|---|---|---|
| Environment | Open space | Urban canyon | Urban canyon |
| Imported Map | Random | Boston | Boston |
| ρ | 3 | 1 | 3 |
| Cₗₒₒₖᵤₚ^{T}^{ᵢ} (hour) | ~0.4 | ~50 | >100 |
| #Rx Locations | L₁^{T} = 1 | L₂^{T} = 200 | L₃^{T} = 200 |

Parameter selection for taking measurements: The highest received power value (in dBm) may be considered of the received ray from each Tx beam at each of the [symbol] Rx location of [symbol] .

Modeling the car obstacle for NLOS scenarios: While a LOS scenario (S1) is ready for simulation runs after setting up the map and fine-tuning all the aforementioned details, there is one more step to finalize an NLOS scenario (S2) for each twin to model and locate the obstacle. Following the FLASH experiments, where the obstacle was a 2018 Toyota Camry with the dimensions of 1.44 m×1.84×4.88 m, height, width, and length, respectively, model this obstacle in WI as a metal box with the same dimensions and place it 35 cm away from the Tx.

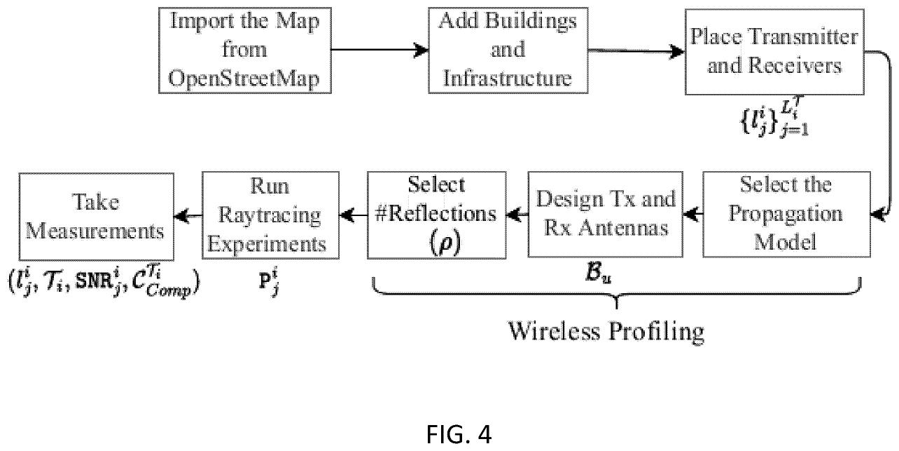

Complete pipeline for twin creation: The modular steps to create different twins is depicted in FIG. 4. This pipeline may be used to create T1, T2, and T3 within the multiverse M.

### Multiverse: Modeling the Antennas

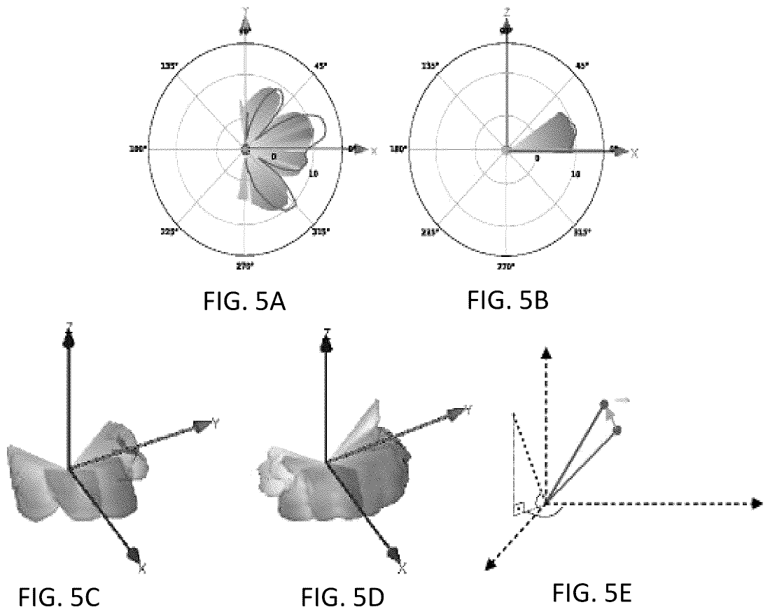

In the real-world experiments used to collect the FLASH dataset, a Talon AD7200 router may be used with Qualcomm's QCA9500 FullMAC IEEE 802.11ad Wi-Fi chip for both Tx and Rx. The router with the Tx role was connected to an antenna array with 32 antenna elements for beam steering, generating 34 valid codebook elements. Therefore, in the FLASH dataset B1=B2=34 for both S1 and S2 scenarios in this paper. From the open source characterization of the antenna pattern, the SNR measurements may be retrieved in 3D for 802.11ad (60 GHz band) to create the Tx and Rx antenna patterns in the multiverse. The 3D legacy azimuth (ϕ) and elevation (θ) measurements span [−90°, 90° ] and [0°, 32.4° ], respectively, having 101 and 10 sample points. The definitions of ϕ and θ used in this paper are visually given in FIG. 5E. The antenna orientations of WI may match the ones in the FLASH dataset on the xy-plane, having the azimuth (ϕ=0°) axis of Tx and Rx parallel (See FIGS. 6A-6F).

Antenna Similarity: In FIGS. 5A-5BE, an example comparison is provided between Talon antenna patterns and the ones created for the WI software to show a visual similarity. FIGS. 5A and 5B provide 2D azimuth (θ=0°) and elevation (q #=0°) patterns, respectively, for the 24^{th} Tx codebook (element t₂₄). The slight discrepancy comes from the fact that WI's user defined antenna patterns only accept sample points with integer increments (ϕₛ, θ_{S}). In order to preserve the complete SNR values, the experimental SNR values may be distributed over the closest azimuth and elevation regions, while keeping ϕ=0 as the reference point; thus, ϕ∈[−100°, 100°] and θ∈[0°, 36° ]. The complete metrics for antenna pattern sample comparison is given in Tab. IV.

TABLE IV
Comparing Talon and WI metrics.

| | ϕ | ϕ_{δ} | θ | θ_{δ} | SNR |
|---|---|---|---|---|---|
| Talon [31] | [−90°, 90°] | 1.89° | [0°, 32.4°] | 3.6° | same |
| WI | [−100°, 100°] | 2° | [0°, 36°] | 4° | same |

In addition to a visual comparison, a quantitative measure may be provided for the antenna similarity metric between Talon and WI. The antenna discrepancy may be measured with an average score from each of these 34 antennas, given by the magnitude of the vector differences between experimental and simulation antenna patterns. A visual vector representation of antenna pattern samples is given FIG. 5E, where ζ_{T} and ζ_{WI} represent points in experimental and simulation antenna pattern, respectively, which were created by corresponding SNR values, ϕ and θ. The discrepancy score for a single antenna, given in Eq. 9, is calculated by averaging the normalized magnitudes of difference vectors, \vec{ζΔ}, where the normalization factor is the magnitude of the corresponding antenna pattern sample (|\vec{ζ_{WI}}|=(|ζ_{T}|).

$${Δ}_{single} = \frac{1}{Q} {\sum }_{i = 1}^{Q} \frac{\vert \vec{{ς}_{WI}} {I}_{i} - \vec{{ς}_{T}} \vert}{\vert \vec{{ς}_{WI}} {I}_{i} \vert} , \qquad ( 9 )$$

where Q=1010 and 0≤Δ_{single}≤2. The final average antenna pattern similarity score is found to be Δ=0.0931, where

$$Δ = \frac{1}{{ℬ}_{1}} {\sum }_{i = 1}^{{ℬ}_{1}} {Δ}_{single} and {ℬ}_{1} = {ℬ}_{2} = 34$$

for both scenarios, S₁ and S₂. Smaller the Δ, more similar the antenna patterns are.

### Multiverse Setup: Baseline Twin T1

Creating a precise map is expensive in terms of time and effort. Also precise map information may not be available all the time, which is important, especially when it comes to spatially sensitive mmWaves. Additionally, location information for Tx, Rx, and all the other important factors that have significant effect on the communication channel must be taken into account for reliable results. Thus, in order to show the gain of precise geometry (which is created for the next twins) and to form a baseline for the evaluations of the simplest model, to use an open area environment. Open area environment is not a free-space, as reflections from the far surrounding buildings in a city is still allowed. The Tx and the only Rx are set around center region of the open area, locating them 4.33 m away, parallel to the smallest Tx-Rx distance in the FLASH experiments. One Rx location may be used, because in the open area experiments, different Rx locations are negligibly affected by the surroundings due to high attenuation. Such an experiment setting significantly cuts both time and computation in beam sweeping and forms a basis for the next twin evaluations, given in V-E and V-F. For this twin, three reflections are allowed in the simulations. The baseline twin is designed for both the LOS (S1) and NLOS (S2) scenarios, with 131=132=34. For the S2, the obstacle may be placed between Tx and Rx, 35 cm away from the the Tx, parallel to the situation in the FLASH experiments.

Specific characteristics: The baseline twin or T1 has: (a) map1=open area, (b) O1=retrieved from FLASH dataset, (c) ρ=3, and (d) L^{T}₁=1.

### Multiverse Setup: 1-Reflection Twin T2

For designing this twin, the simulation environment is switched to the location, where the FLASH experiments took place in order to have more realistic simulation results. Creating the realistic environment and using antenna patterns from real life measurements brings a trade-off between significantly increased computation time and precision in beam selection and received power. Recall that the virtual world computations are intended to be offline, which will provide a dictionary to look up during decision making in beam selection in real life. Thus, the extended offline computation time does not affect beam selection speed during live operation. The Tx point is set in WI by precisely measuring the Tx location at the FLASH experiment location and comparing the geometry of the real world and WI buildings. In WI simulations, received beam information is collected at 200 consecutive points, which are uniformly distribute over a 40 meter trajectory, Tx being 4.33 m away from the trajectory's middle point (see FIG. 3D). One reflection is allowed in the simulations to save on computation time and to realize the effects of simpler settings that mostly allow LOS communication. For both the LOS (S1) and NLOS (S2) scenarios, with 131=132=34, for this twin as well. For S2, the obstacle may be placed between Tx and Rx, 35 cm away from the Tx, parallel to the situation in the FLASH experiments.

Specific characteristics: For 1-reflection twin T2: (a) map2=Boston, (b) O2=retrieved from FLASH dataset, (c) ρ=1, and (d) LT2=200.

### Multiverse Setup: 3-Reflection Twin T3

This twin creates a more comprehensive setting in the virtual world in order to provide a more precise beam selection, even in NLOS cases. Three reflections may be allowed in the simulations to cope with potentially dense reflective environments. Like T2 in V-E, the simulations are run at the same place as the FLASH dataset was collected. Also 1 Tx, 200 Rx samples are used and the same obstacle settings as in T2 for both the S1 and S2 scenarios.

Specific characteristics: Finally, for 3-reflection twin T3: (a) map3=Boston, (b) O3=retrieved from FLASH dataset, (c) ρ=3, and (d) L^{T}₃=200.

### Multiverse Representative Raytracing

FIGS. 6A-6F illustrate a set of examples for the first, second, and fifth strongest received rays at Rx130, using antenna-10 (t10) at the Tx in multiverse M for T1, T2, and T3 for both S1 and S2 scenarios. Red ray is the strongest one, while the ray power decreases towards colder color (red-+yellow-+green). Antenna locations are correct, while their patterns are not in scale, enlarged for visual purposes. Due to the mismatch of Tx and Rx antenna height, there was no direct path for line-of-sight (LOS) rays when the antennas are directly in front of each other.

As shown in FIGS. 6A-6F, a white rectangle in FIGS. 6B, 6D, and 6F illustrate a blockage in front of the transmitter to model a NLOS scenario. The lines illustrate propagation rays. The ray with the red color is the strongest one, while the yellow and the green are next strongest (e.g., red→yellow→green in descending order). The rays may be used to compute a metric SNR (signal to noise ratio) for different locations, and is provided as beam data generated for each twin.

A collection of outputs from the representative raytracing analysis in the WI simulator for T1, T2, and T3 w.r.t LOS scenario, S1, and NLOS scenario, S2, is presented in FIGS. 6A-6F. Different Rx locations are denoted in T2, and T3 with Rxi where 1<i<L^{T}₂, L^{T}₃, respectively. Note that: L^{T}₁=1, L^{T}₂=L^{T}₃=200. For T1, the only Rx location is denoted as ‘Rx’. In FIGS. 6A-6F, the Tx and _{Rx130} are used for communication for T2, and T3, whereas _{Rx100} (middle sample point) is given for location reference. In all examples, Antenna-10 ₍ₜ₁₀₎ is used at Tx. The corresponding antenna patterns may be enlarged for visual purposes, but keep their location precise. In each sub-figure, red ray delivers the highest power and ray strength decreases in the order of red-+yellow-+green, where they represent first, second, and fifth strongest ray.

Due to the height difference between Tx and Rx, which comes from the precise heights set for the antennas following the FLASH experiment setting, and the available antenna patterns from Talon, when the antennas' ϕ=0° axes are aligned and the antennas are close, no direct ray is possible. Thus, rays in T1, given in FIGS. 6A and 6B, are delivered by reflection and diffraction from distant buildings, which by design information is not known about, making results less reliable. This suggests the idea that a carefully created twin at the same experiment location would yield more robust results, which in fact, is confirmed as described below through evaluation.

As the antennas start becoming more distant, the height difference is compensated by longer ray travel distance, making a direct ray between Tx and Rx possible. This is what may be observed in LOS cases in 6c and 6e. In T2 and T3, direct paths are identical, having the p10
2=p10
3=−69.65 dBm. The rest of the LOS rays tend to be drastically different due to the allowed number of reflections (ρ). In FIG. 6C, yellow and green rays are delivered to the Rx with at most one reflection, whereas in FIG. 6E these rays are able to undergo multiple reflections.

In NLOS cases direct path is prevents. Thus, rays have to undergo reflections and/or diffractions in order to reach to the Rx. This is where the difference may be observed between ρ₂¹⁰ and ρ₃¹⁰. [symbol] rays are only allowed to reflect once compared to [symbol] , where ρ=3. Thus, in [symbol] , rays are more likely to travel longer to arrive at Rx when there is no direct path. This way, signals in [symbol] attenuate more, causing lower received power for the strongest beam, e.g., ρ₂¹⁰=−108.4 dBm and ρ₃¹⁰=−78.16 dBm in FIGS. 6D and 6F, respectively. Again, due to different ρ, yellow and green rays follow different paths in NLOS cases.

Broader observation: Overall, it is observed ρ₃^{m}≥ρ₂^{m}. More accurate beam matching performance for [symbol] may be expected, as described below.

### Performance of the Multiverse

The proposed multiverse-based beam selection may be validated using the FLASH dataset, as described below. The multiverse may include three twins, [symbol] ={ [symbol] } as discussed earlier.

### Evaluation Metrics

Given the ground-truth measurements from FLASH dataset, G∈ [symbol] , and the SNRs S∈ [symbol] for [symbol] beams (either obtained from multiverse or predicted by ML-based method), the beam selection performance is evaluated as:

$${Acc}_{( K , T )} = \frac{1}{V} {\sum }_{l = 1}^{V} {𝟙}_{( ∃ g ⊂ G \vert g ∈ {S}_{k} )} , \qquad ( 10 )$$

where V denotes the number of samples and τ is a Boolean predicate, with [symbol] to be 1 if τ is true, and 0 otherwise. In Eq. 10, the set g denotes a subset of beams in G (ground-truth from FLASH dataset) such that the observed SNR of beams in g is within the T−dB threshold of the optimum beam, i.e., g={bⱼ∈ [symbol] |SNR_{b}_{ⱼ}≥SNR_{b*}−T}, where SNR_{b*} denotes the SNR of the optimum beam from FLASH ground-truth. Moreover, S_{K} denotes the top-K beams obtained by either multiverse or a CNN, defined as:

$${S}_{K} = \{ s \vert {arg max}_{s ⊂ \{ 1 , … , \vert ℬ \vert \} , \vert s \vert = K} {\sum }_{j ∈ s} {SNR}_{{b}_{j}} \} , \qquad ( 11 )$$

where SNR_{b}_{ⱼ} denotes the inferred SNR for beam bⱼ. This is intuitive as observations indicate that there are closely competitive beam in Talon and selecting any of them results in a favorable observed SNR. For T=0 and K=1, the conventional top-1 accuracy may be obtained, where only the best beam in FLASH is compared with the best inferred beam.

### Motivation for Multiverse

A scenario may be considered where the mmWave beam initialization is performed by relying on multimodal data and predicting the optimum beam using a CNN. The models released publicly along with the FLASH dataset may be used to train a CNN. The proposed architecture is inspired by ResNet and exploits feature level fusion to reinforce the prediction by incorporating the multimodal data from all modalities. Tab. V benchmarks the performance of the ML-based method when the CNN is trained on one scenario and tested on another (unseen), e.g. trained on LOS scenario S1 and tested on NLOS scenario S2. The maximum drop in accuracy _{(Acc(1,0))} is 73.42% while making a transition from S2 to S1 scenarios. Thus, an ML-only method fails when unseen environments are encountered.

TABLE V
The Acc_{(1, 0)} while being exposed to the unseen environments.
The ML-based methods experience extensive drop in accuracy
due non-adaptability to the changes in the environment.

| | | Test Acc_{(1, 0)} | | |
|---|---|---|---|---|
| Train Scenario | Train Acc_{(1, 0)} | S₁ | S₂ | Drop in Acc_{(1, 0)} |
| S₁ (LOS) | 83.9 | 66.40 | 10.30 | 56.1 |
| S₂ (NLOS) | 90.97 | 5.96 | 79.38 | 73.42 |

### Validation of the Multiverse Concept

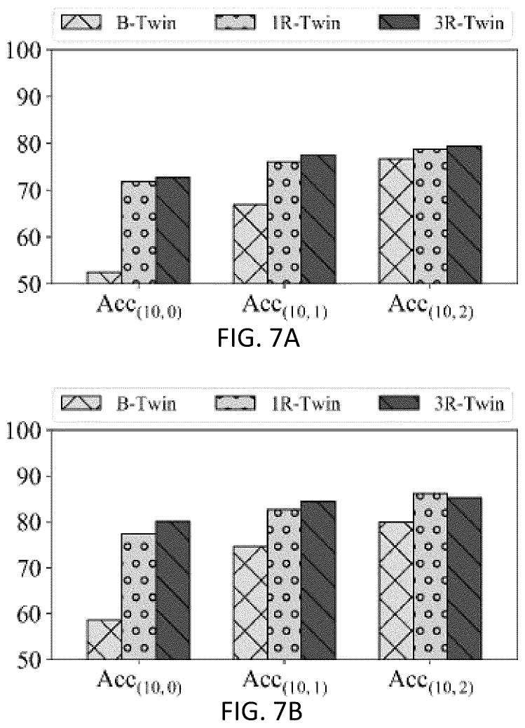

In FIGS. 7A and 7B, the performance of multiverse is compared against the ground-truth measurements from the FLASH dataset to validate the fidelity of simulation outputs. The metric Acc(K,T) in Eq. 10 is reported. The parameter K is set as 10 and gradually relax the SNR threshold T with T={0, 1, 2}. Note that T=0 is most extreme case where only the optimum beam in FLASH is considered for justification. From FIGS. 7A and 7B, for the LOS scenario, Baseline twin 71 provides the Acc(10,0) of 52.38% while 1-Reflection and 3-Reflection twins 72 and 73 perform closely with accuracy of 71.74% and 72.69%, respectively. The Acc(10,0) increases as the threshold is relaxed on SNR and ranges between 76-79% across all three twins. For NLOS scenario S2, 3-Reflection twin 73 exhibits superiority in Acc(10,0) against 71 and 72 by 21.49% and 2.78%.

Broader observation: Overall, the designed multiverse M depicts the accuracy ranging between 52.38-80.08%, 66.92-84.41% and 76.63-85.22% for SNR thresholds of 0, 1 and 2 dB, respectively, for both LOS S1 and NLOS S2 scenarios across all twins.

### Comparing the Performance of Twins

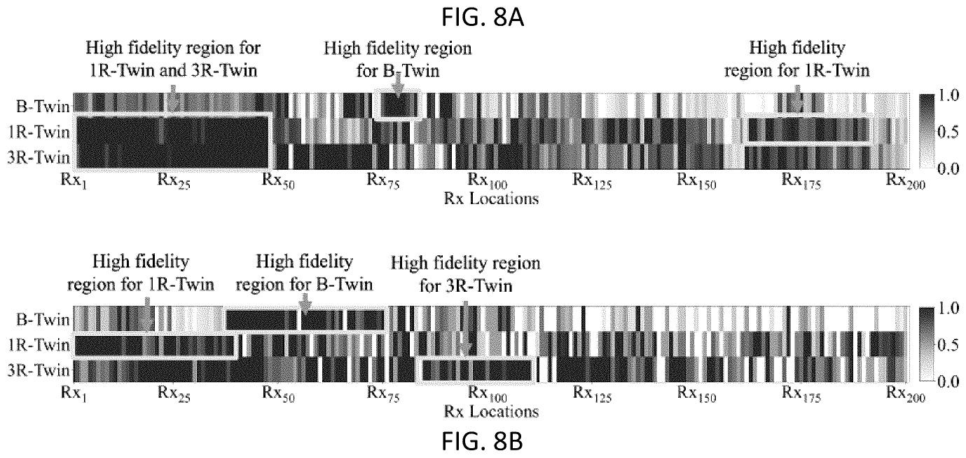

In FIGS. 8A and 8B, the probability of inclusion p(K, LT(7i), Si, r) for K=10, three twins, and both LOS S1 and NLOS S2 scenarios are compared. In this figure, each cube represents the location of the road r for which the probability of inclusion is calculated, with 20 cm spacing as explained below. From this figure three observations may be concluded. First, the performance of the twins depends on the location of the receiver on the road. This is intuitive as the number of reflections in real world might vary in each location, unlike multiverse where it is constant for each twin. As a result, each twin might be closer to the real-world scenario on a case by case basis. This is also in support to the idea of region wise selection of twins in Eq. 8. Second, 3-Reflection twin 73 performs better than 71 and 72 with the average probability of inclusion of 74.87-78.68% compared to that of 43.90-47.48% and 66.43-76.60% for both LOS S1 and NLOS S2 scenarios, respectively. Third, the multiverse provides higher probability of inclusion in the S1 compared to S2 by 4-8% margin.

### Digital Twin Selection

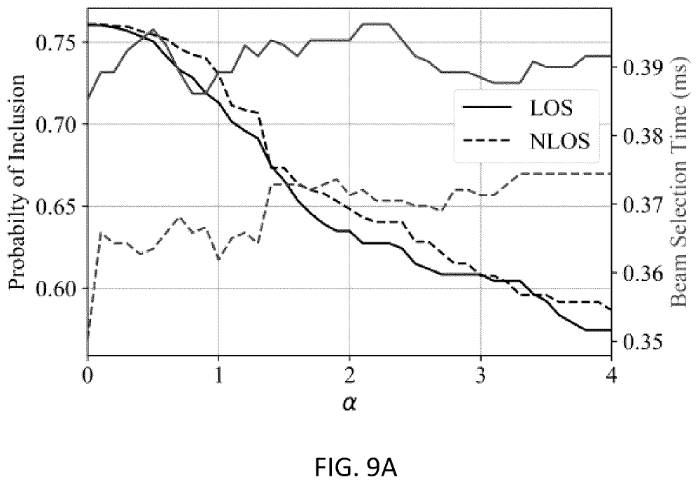

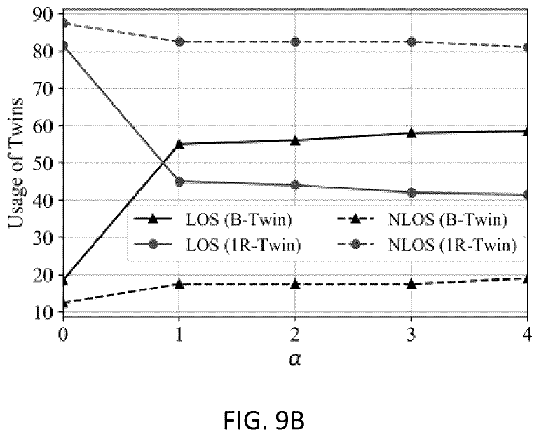

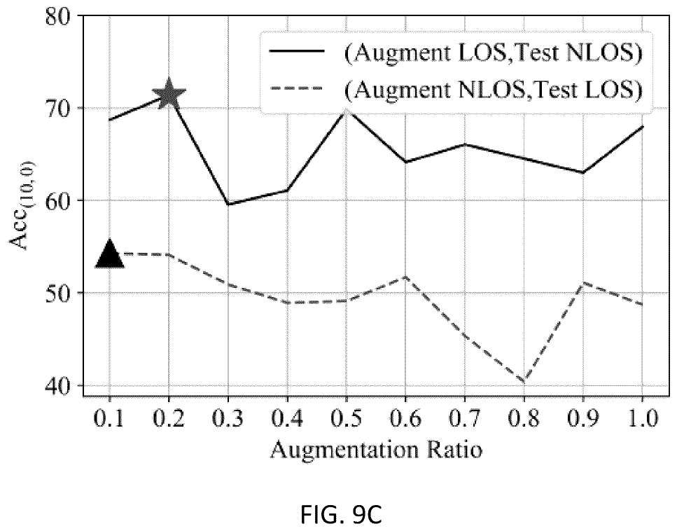

The proposed method selects the best twin according to the user defined constraints on communication and computation latency. FIG. 9A illustrates the effect of control parameter on the optimization problem in Eq. 8 for LOS S1 and NLOS S2 scenarios. By increasing the probability of inclusion decreases while a fluctuating pattern in beam selection time. Note, that by increasing the optimization problem in Eq. 8 is enforced to decrease K and select the twins with lower communication and computation cost. On the other hand, decreasing K motivates choosing twins with higher probability of inclusion to maximize the objective. The monotonic decrease in probability of inclusion in FIG. 9A indicates that this metric is mostly effected by K and is less sensitive to the twins. On the other hand, the beam selection time is affected by both K and twins which results in fluctuations observed in FIG. 9A as changes.

Effect of latency constraints: In Tab. VI, the percentage of the times that each of the twins were selected under three communication latency constraints, CComm1=0.78 ms, CComm2=1.56 ms and CComm3=2.34 ms. Moreover, the selection percentage for ={0, 0.2}. For =0, as the constraint on communication latency is relaxed, the percentage of the times that the twin with higher complexity (and higher probability of inclusion) is selected increases. In particular, the usage for 1-Reflection twin 72 decreases from 51% and 33% to 26% and 25.5% for LOS and NLOS scenarios, respectively. On the other hand, the usage for 3-Reflection twin 73 increases by 23% and 4% for each scenario. This is intuitive as relaxing the communication latency constraint indicates that the users are inclined to have a more robust than fast communication; thus, the twin with higher complexity and higher probability of inclusion is more likely to be chosen. For Baseline twin 71, significant change is not observed in usage of each twin and a range of 4.5-8.5% for all communication latency constraints and both LOS S1 and NLOS S2 scenarios.

TABLE VI
The break down of the usage for three twins in multiverse
for LOS S₁ and NLOS S₂ scenarios while imposed with three
communication latency constraints and α = {0, 0.2}. When α =
0, relaxing the communication constraint results in an increase
in choosing τ₃ and decrease in choosing τ₁ and τ₂. However,
when α ≠ 0, the urge to select the twin with lower communication
and computation complexity leads to increasing the usage of
τ₁ with minimum computation complexity.

| | LOS S₁ (α = 0) | | | LOS S₁ (α = 0.2) | | |
|---|---|---|---|---|---|---|
| Twin | C_{Comm}_{₁} | C_{Comm}_{₂} | C_{Comm}_{₃} | C_{Comm}_{₁} | C_{Comm}_{₂} | C_{Comm}_{₃} |
| B-Twin (τ₁) | 6.5 | 4.5 | 8.5 | 35.5 | 61.5 | 78 |
| 1R-Twin (τ₂) | 51 | 32.5 | 26 | 57.5 | 36.0 | 20 |
| 3R-Twin (τ₃) | 42.5 | 63 | 65.5 | 7 | 2.5 | 2 |
| | NLOS S₂ (α = 0) | | | NLOS S₂ (α = 0.2) | | |
| Twin | C_{Comm}_{₁} | C_{Comm}_{₂} | C_{Comm}_{₃} | C_{Comm}_{₁} | C_{Comm}_{₂} | C_{Comm}_{₃} |
| B-Twin (τ₁) | 5 | 7 | 8.5 | 27 | 52 | 67 |
| 1R-Twin (τ₂) | 33 | 27.5 | 25.5 | 54.5 | 38.5 | 28 |
| 3R-Twin (τ₃) | 62 | 65.5 | 66 | 18.5 | 9.5 | 5 |

For =0.2, although the communication latency is relaxed, the usage for 72 and 73 decreases, while the usage for the 71 increases. In particular, in this case, usage of 71 increases by 40-45.5% while the usage of 72 and 73 decreases by 26.5-37.5% and 5-13.5%, respectively. Note that by relaxing the communication latency constraint, the probability of inclusion increases. On the other hand, by imposing the second term in Eq. 8 with higher weights, the second term effect is more pronounced. Thus, the optimization problem is more likely to choose Baseline twin 71 with less computation time, despite relaxing the communication constraint.

Effect of computation constraints: The computation complexity of three twins in multiverse is related as T1<T2<T3. In this experiment, a scenario is considered in which T3 is not a viable option due to computation constraints. Moreover, the communication constraint may be changed to be CComm1=0.78 ms. In FIG. 9B, the model usage versus a for T1 and T2. For α=0, it may be observed, the usage for T1 and T2 is 18.5% and 81.5% for LOS scenario S1 and 12.5%, 87.5% for NLOS scenario S2, respectively. Moreover, as a increases, the optimization problem in Eq. 8 is choosing T1 more often.

### Augmenting the Real-World

A scenario may be considered in which a percentage of labels from multiverse, which is referred to as augmentation ratio, is paired with the local multimodal sensor data to retrain the local model at vehicle. For testing, the labels from FLASH dataset are used. The labels are generated from 3-Reflection twin T3 in multiverse M which offers the highest probability of inclusion. In one experiment, the multimodal sensor data and labels from FLASH ground-truth for S1 are used. Then label the sensor data within S2 using the designed multiverse M (not FLASH) and train the model. Then repeat the same experiment with S1 and S2 role-reversed. The model architecture released by FLASH framework is used. In FIG. 9C, reports the Acc(10,0) for both cases. The Acc(1,0)^{an}d Acc(10,0) for LOS S1 and NLOS S2 scenarios in multiverse range between 41-72% and 47-80%, respectively. On the other hand, Acc(10,0) with augmentation ranges between 40.35-54.27% and 59.54-69.84% for S1 and S2. Interestingly, the Acc(10,0) with augmentation is within the Acc(1,0)^{and} Acc(10,0) from multiverse. The labeling strategy in FLASH framework in one-hot encoding; thus, it is expected for the accuracy with augmentation to be higher than Acc(1,0) from multiverse. On the other hand, since the labels are synthetically generated, the augmentation accuracy is bounded by Acc(10,0) from multiverse. The best performance for augmentation percentage of 0.1 and 0.2 for S1 and S2, respectively, marked with star and triangle in FIG. 9C.

Comparing against Exhaustive Search

In multiverse, a look up table for each twin is sent in the downlink. This look up table includes information about expected SNR of each beam across all Rx locations along with the computation cost for each twin. The vehicle computes the probability of inclusion on the training data. Whenever, the ML-based method identified as faulty, the vehicle runs the optimization problem in Eq. 8 to obtain the optimum twin and associated top-K beams according to its computation and communication constraints. The aforementioned look up tables for each twin occupy maximum ˜28 KB per twin. Moreover, the Talon AD7200 router offer communication in both mmWave and 5 GHz bands. The 5 GHz is considered as the control channel that provides data rate of 1733 Mbps. As a result, sending the look up tables in downlink takes ˜0.1292 ms. On the other hand, the local execution of Eq. 8 takes ˜23 μs on a commercial laptop. Moreover, the selected top-K beams in multiverse are bounded by 12 while targeting the inclusion probability of 97% (there is no need to sweep more than 12 beams). This corresponds to beam sweeping times of 0.0373 ms (K=1) and 0.4482 ms (K=12), respectively. Thus, it may be concluded that the end-to-end latency of multiverse ranges between 0.1895 ms and 0.6004 ms. On the other hand, sweeping the 34 sector with exhaustive search and 802.11ad standard takes 1.27 ms.

Broader observation: A 52.72-85.07% improvement in beam selection time may be attained compared to 802.11ad standard.

The methods and techniques described herein expand the digital twin concept towards a multiverse of twins and demonstrate an application for mmWave beam selection in V2X scenarios. The twins play a vital role when local DL methods are insufficient due to environment changes and the exhaustive beam search is difficult due to mobility. Each twin, created in Wireless InSite simulator with different settings, captures the real world with different cost/fidelity tradeoff. Accordingly, each twin prepares a beam selection dictionary for a quick reference when the environment change is detected. The beam selection decisions by the multiverse are validated through the experimental dataset, FLASH. The evaluations show that this multiverse can correctly predict the top-K beams up to 85.22% accuracy. The multiverse-based method yields up to 85.07% improvement in beam selection time compared to 802.11ad standard.

Novel aspects of the methods and techniques described herein include the following. The main contributions of this technology are as follows: 1. Extending single twins to the multiverse of twins. The concept of the multiverse is utilized, where different pairs of twins emulate the real world with varying levels of fidelity, depending on their computational cost and permissible latency. 2. Choosing the twin in the multiverse. An optimization algorithm is employed that takes into account the fidelity of the twins and user-defined communication and computation constraints to automatically select the optimum digital twin from multiverse and associated top-K beams in a case-by-case basis. This is locally executed on the vehicle with complexity O(N) with N being the number of twins in multiverse. 3. Data augmentation from the multiverse. A novel data augmentation framework is used, which leverages the selected beams from the multiverse to retrain the real-world DL models in actual deployment conditions, and generalize them to unseen environments. The labels from multiverse and local sensor data are paired to retrain the local model. 4. Validation of multiverse for beam selection in V2X network. The multiverse concept has been rigorously evaluated, including how well a twin's predictions match with the ground truth using a publicly available real-world FLASH dataset for V2X communication. The results reveal that, combined with state-of-the-art environment change detection algorithms, the multiverse offers up to 79.43% and 85.22% top-10 best beam selection accuracy for LOS and NLOS scenarios, respectively. Intuitively, it is observed that the top-10 accuracy with augmentation is bounded by top-1 and top-10 accuracy with the multiverse. Finally, it is demonstrated that the multiverse decreases the beam selection overhead by 52.72-85.07% compared to the exhaustive search method proposed by the state-of-the-art standard. 5. The ‘multiverse’ dataset. The first-of-its-kind dataset and simulation code will be published for three twins operating in the multiverse with precise maps, experimentally measured antenna patterns and building materials using the Wireless InSite software. APIs are provided to interface the Wireless InSite software framework with the previously released FLASH dataset obtained from a sensor-equipped Lincoln MKZ autonomous car.

Advantages of the methods and techniques described herein over previous implementations include the following. 1. The present technology uses multiple digital twins to replicate the real world with different level of fidelity and cost trade-off 2. The present technology uses a novel optimization algorithm that takes into account the fidelity of the twins and user-defined communication and computation constraints to automatically select the optimum digital twin from multiverse and associated top-K beams in a case-by-case basis. 3. The present technology uses a novel data augmentation framework which leverages the selected beams from the multiverse to retrain the real-world deep learning models in actual deployment conditions, and generalize them to unseen environments. 4. This technology yields 52.72-85.07% improvement in beam selection time compared to the 802.11ad standard. It also offers latency and computational constraints at the network edge shape the continuous interaction between the multiverse of twins, as opposed to a one-time emulation that is completed prior to actual deployment. The technology achieves up to 79.43% and 85.22% top-10 accuracy for LOS and NLOS scenarios, respectively.

Potential uses of the methods and techniques described herein include the following. 1. Ultra-low latency and ultra-high bandwidth communication. 2. Next generation vehicle-to-everything communication. 3. Ultra-fast AR/VR streaming platforms. 4. The technology uses existing sensors (LiDAR, camera, GPS: which are already deployed in modern autonomous vehicles) and mmWave radios (which are envisioned to be integrated with future autonomous vehicles) of the vehicle. The software and the architecture can be integrated with the future mmWave based V2X communication system.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

While the present invention has been described in conjunction with certain preferred embodiments, one of ordinary skill, after reading the foregoing specification, will be able to effect various changes, substitutions of equivalents, and other alterations to the compositions and methods set forth herein.

### REFERENCES

[1] H. X. Nguyen, R. Trestian, D. To, and M. Tatipamula, “Digital twin for 5 g and beyond,” IEEE Communications Magazine, vol. 59, no. 2, pp. 10-15, 2021.
[2] L. U. Khan, W. Saad, D. Niyato, Z. Han, and C. S. Hong, “Digital-twin-enabled 6 g: Vision, architectural trends, and future directions,” IEEE Communications Magazine, vol. 60, no. 1, pp. 74-80, 2022.
[3] B. Salehi, G. Reus-Muns, D. Roy, Z. Wang, T. Jian, J. Dy, S. Ioannidis, and K.

Chowdhury, “Deep learning on multimodal sensor data at the wireless edge for vehicular network,” IEEE Transactions on Vehicular Technology, vol. 71, no. 7, pp. 7639-7655, 2022.
[4] B. Salehi, J. Gu, D. Roy, and K. Chowdhury, “FLASH: Federated Learning for Automated Selection of High-band mmWave Sectors,” in IEEE INFOCOM 2022-IEEE Conference on Computer Communications. IEEE, 2022, pp. 1719-1728.
[5] “Wireless InSite, 3D Wireless Prediction Software,” https://www. remcom.com/wireless-insite-em-propagation-software, accessed: 2022,10-10.
[6] “FLASH Dataset,” https://genesys-lab.org/multimodal-fusion-nextg-v2x-communications.
[7] A. Gritsenko, Z. Wang, T. Jian, J. Dy, K. Chowdhury, and S. Ioannidis, “Finding a ‘new’ needle in the haystack: Unseen radio detection in large populations using deep learning,” in IEEE International Symposium on Dynamic Spectrum Access Networks (DySPAN), 2019, pp. 1-10.
[8] J. Nitsch, M. Itkina, R. Senanayake, J. Nieto, M. Schmidt, R. Siegwart, M. J. Kochenderfer, and C. Cadena, “Out-of-distribution detection for automotive perception,” in IEEE International Intelligent Transportation Systems Conference (ITSC), 2021, pp. 2938-2943.
[9] R. Dong, C. She, W. Hardjawana, Y. Li, and B. Vucetic, “Deep learning for hybrid 5g services in mobile edge computing systems: Learn from a digital twin,” IEEE Transactions on Wireless Communications, vol. 18, no. 10, pp. 4692-4707, 2019.
[10] Y. Lu, S. Maharjan, and Y. Zhang, “Adaptive edge association for wireless digital twin networks in 6 g,” IEEE Internet of Things Journal, vol. 8, no. 22, pp. 16 219-16 230, 2021.
[11] W. Sun, S. Lian, H. Zhang, and Y. Zhang, “Lightweight digital twin and federated learning with distributed incentive in air-ground 6 g networks,” IEEE Transactions on Network Science and Engineering, pp. 1-13, 2022.
[12] Y. Li, K. Li, L. Cheng, Q. Shi, and Z.-Q. Luo, “Digital twin-aided learning to enable robust beamforming: Limited feedback meets deep generative models,” in 2021 IEEE 22nd International Workshop on Signal Processing Advances in Wireless Communications (SPAWC), 2021, pp. 26-30.
[13] B. Vilas Boas, W. Zirwas, and M. Haardt, “Machine learning for csi recreation in the digital twin based on prior knowledge,” IEEE Open Journal of the Communications Society, vol. 3, pp. 1578-1591, 2022.
[14] D. Chen, D. Wang, Y. Zhu, and Z. Han, “Digital twin for federated analytics using a bayesian approach,” IEEE Internet of Things Journal, vol. 8, no. 22, pp. 16 301-16 312, 2021.
[15] N. Zeulin, A. Ponomarenko-Timofeev, O. Galinina, and S. Andreev, “Ml-assisted beam selection via digital twins for time-sensitive industrial iot,” IEEE Internet of Things Magazine, vol. 5, no. 1, pp. 36-40, 2022.
[16] W. Chen, L. Li, Z. Chen, T. Quek, and S. Li, “Enhancing thz/mmwave network beam alignment with integrated sensing and communication,” IEEE Communications Letters, vol. 26, no. 7, pp. 1698-1702, 2022.
[17] T. Nitsche, C. Cordeiro, A. B. Flores, E. W. Knightly, E. Perahia, and J. C. Widmer, “Ieee 802.11 ad: directional 60 ghz communication for multi-gigabit-per-second wi-fi [invited paper],” IEEE Communications Magazine, vol. 52, no. 12, pp. 132-141, 2014.
[18] A. Klautau, N. Gonzilez-Prelcic, and R. W. Heath, “Lidar data for deep learning-based mmwave beam-selection,” IEEE Wireless Communica,tions Letters, vol. 8, no. 3, pp. 909-912, 2019.
[19] A. Ali, N. Gonzilez-Prelcic, and R. W. Heath, “Millimeter wave beam-selection using out-of-band spatial information,” IEEE Transactions on Wireless Communications, vol. 17, no. 2, pp. 1038-1052, 2018.
[20] C. Finn, P. Abbeel, and S. Levine, “Model-agnostic meta-learning for fast adaptation of deep networks,” in Proceedings of the 34th Intena¬tional Conference on Machine Learning—Volume 70, ser. ICML'17, 2017, p. 1126-1135.
[21] A. Fallah, A. Mokhtari, and A. Ozdaglar, “Generalization of model-agnostic meta-learning algorithms: Recurring and unseen tasks,” in Advances in Neural Information Processing Systems, M. Ranzato, A. Beygelzimer, Y. Dauphin, P. Liang, and J. W. Vaughan, Eds., vol. 34. Curran Associates, Inc., 2021, pp. 5469-5480.
[22] D. Gao, Y. Xie, Z. Zhou, Z. Wang, Y. Li, and B. Ding, “Finding meta winning ticket to train your maml,” in Proceedings of the 28th ACM SIGKDD Conference on Knowledge Discovery and Data Mining, ser. KDD '22, 2022, p. 411-420.
[23] L. Collins, A. Mokhtari, and S. Shakkottai, “Task-robust model-agnostic meta-learning,” in Advances in Neural Information Processing Systems, vol. 33. Curran Associates, Inc., 2020, pp. 18 860-18 871.
[24] “Wireless InSite References,” https://www.remcom.com/wireless-insite-references, accessed: Nov 2022.
[25] E. Techapanurak, M. Suganuma, and T. Okatani, “Hyperparameter-free out-of-distribution detection using cosine similarity,” in Proceedings of the Asian Conference on Computer Vision (ACCV), November 2020.
[26] X. Dong, J. Guo, A. Li, W.-T. Ting, C. Liu, and H. Kung, “Neural mean discrepancy for efficient out-of-distribution detection,” in Proceedings of the IEEE/CVF Conference on Computer Vision and Pattern Recognition (CVPR), June 2022, pp. 19 217-19 227.
[27] C. N. Barati, S. Dutta, S. Rangan, and A. Sabharwal, “Energy and Latency of Beamforming Architectures for Initial Access in mmWave Wireless Networks,” Journal of the Indian Institute of Science, pp. 1-22, 2020.
[28] D. Steinmetzer, D. Wegemer, M. Schulz, J. Widmer, and M. Hollick, “Compressive Millimeter-Wave Sector Selection in Off-the-Shelf IEEE 802.11ad Devices,” International Conference on emerging Networking EXperiments and Technologies (CoNEXT), 2017.
[29] “OpenStreetMap,” https://www.openstreetmap.org, accessed: 2022-06,30.
[30] “Blender,” https://www.blender.org, accessed: 2022-06-30.
[31] D. Steinmetzer, D. Wegemer, M. Schulz, J. Widmer, and M. Hollick, “Compressive millimeter-wave sector selection in off-the-shelf ieee 802.11 ad devices,” in Proceedings of the 13th International Conference on emerging Networking EXperiments and Technologies, 2017, pp. 414-425.
[32] “WiFi Routers—AD7200,” https://www.tp-link.com/us/home-networking/wifi-router/ad7200/#specifications, accessed: 2022,11-11.
[33] “Legacy measurements,” https://github.com/seemoo-lab/
[34] talon-sector-pattems/tree/master/legacy measurements, accessed: 2022-11-11.
K. He, X. Zhang, S. Ren, and J. Sun, “Deep Residual Learning for Image Recognition,” in CVPR, 2016, pp. 770-778.

What is claimed is:

1. A system for operating an autonomous vehicle in a local environment, the system comprising:
(i) an autonomous vehicle comprising a computer, one or more sensors, and a transceiver for communication with a wireless network disposed in the local environment; and
(ii) an edge server in communication with the wireless network and with a cloud server, wherein the edge server is in communication with the autonomous vehicle through the transceiver and the wireless communications network;
wherein the vehicle computer comprises a trained model of the local environment and instructions for evaluating data from the sensors, identifying a change in the local environment compared to the trained model, and updating the trained model; and
wherein the edge server comprises instructions for producing a multiverse of twins of the local environment and selecting a preferred one of said twins upon request from the autonomous vehicle.

2. The system of claim 1, wherein the sensors comprise one or more of a camera, a geographical positioning system (GPS) receiver, and a light detection and ranging (LiDAR) device.

3. The system of claim 1, wherein the cloud server and/or the edge server comprise one or more twins of the local environment or other data for use and/or modification in producing the multiverse of twins.

4. The system of claim 1, wherein the local environment is an urban environment.

5. The system of claim 1, wherein the change in the local environment comprises one or more of a road blocking vehicle or object, a detour, a building, a construction site, first responder activity, a pedestrian, a fire, or a weather-related hazard.

6. The system of claim 1, wherein the multiverse of twins comprises two or more twins of the local environment differing from one another in one or more representation factors of the local environment.

7. The system of claim 6, wherein the representation factors are selected from a number of reflections of one or more electromagnetic beams of the wireless network and an image resolution.

8. The system of claim 1, wherein the wireless network is a mmWave wireless network.

9. A method of operating an autonomous vehicle in a local environment, the method comprising the steps of:
(a) determining a change in the local environment by comparing data from one or more sensors of the autonomous vehicle to stored data representing the local environment;
(b) transmitting the sensor data representing the local environment from a vehicle transceiver to an edge server;
(c) determining, based on the sensor data, a preferred twin from a multiverse of twins, wherein the multiverse of twins comprises two or more twins of the local environment differing from one another in one or more representation factors of the local environment;
(d) transmitting the preferred twin from the edge server to the transceiver of the autonomous vehicle;
(e) determining, using the preferred twin, beam direction data for communicating with a base station in the local environment; and
(ƒ) transmitting, based on the beam direction data, data from the vehicle transceiver to the base station.

10. The method of claim 9, wherein the representation factors are selected from a number of reflections of one or more electromagnetic beams of the wireless network and an image resolution.

11. The method of claim 9, wherein the vehicle sensor data are received from one or more of a camera, a GPS receiver, or a LiDAR device of the vehicle.

12. The method of claim 9, wherein determining the preferred twin comprises identifying a latency constraint.

13. The method of claim 12, wherein the latency constraint is caused by blockage of one or more electromagnetic beams of the wireless network by said change in the local environment.

14. The method of claim 13, wherein determining the preferred twin comprises selecting a twin comprising information describing one or more reflections of the one or more blocked beams.

15. The method of claim 9, wherein the wireless network is a mmWave wireless network.

16. The method of claim 9, wherein step (c) comprises using an algorithm, and wherein the algorithm is
$${C}^{5 G - NR} ( K ) = {T}_{p} \times [ \frac{K - 1}{32} ] + {T}_{ssb} .$$

17. A system for operating an autonomous vehicle in a local environment, comprising:
at least one processor; and
memory including instructions that, when executed by the at least one processor, cause the at least one processor to:
determine, using sensor data from one or more vehicle sensors, a change in the local environment by comparing the sensor data from the vehicle sensors to stored data representing the local environment;
transmit, from a vehicle transceiver to an edge server, the sensor data representing the local environment;
determine, based on the sensor data, a preferred twin from a multiverse of twins, wherein the multiverse of twins comprises two or more twins of the local environment differing from one another in one or more representation factors of the local environment;
transmit the preferred twin from the edge server to the transceiver of the autonomous vehicle;
determine, using the preferred twin, beam direction data for communicating with a base station in the local environment; and
transmit, based on the beam direction data, data from the vehicle transceiver to the base station.

18. The system of claim 17, wherein the representation factors are selected from a number of reflections of one or more electromagnetic beams of the wireless network and an image resolution.

19. The system of claim 17, wherein the vehicle sensor data is received from one or more of a camera, a GPS receiver, and a LiDAR device of the vehicle.

20. The system of claim 17, wherein the wireless network is a mmWave wireless network.
